(19) United States
(12) Patent Application Publication
(10) Pub. No.: US 2024/0308768 A1
(43) Pub. Date: Sep. 19, 2024

(54) WAREHOUSING SYSTEM FOR STORING AND RETRIEVING GOODS IN CONTAINERS

(71) Applicant: Symbotic LLC, Wilmington, MA (US)

(72) Inventor: Nate Watts, Jefferson, MA (US)

(21) Appl. No.: 18/605,261

(22) Filed: Mar. 14, 2024

Related U.S. Application Data
(60) Provisional application No. 63/452,735, filed on Mar. 17, 2023.

(51) Int. Cl. B65G 1/137; B65G 1/04; B66F 9/06; B66F 9/075; B66F 9/19

(52) U.S. Cl. CPC B65G 1/1375; B65G 1/0492; B66F 9/063; B66F 9/0755; B66F 9/195; B65G 2201/0258

(57) ABSTRACT

An autonomous transport vehicle for transferring a goods unit for filling a shipping tote or container, the autonomous transport vehicle comprising, a frame configured so that the autonomous transport vehicle traverses, as a unit, on at least one of a transfer deck and a ramp, a controller connected to the frame and configured to effect movement of the autonomous transport vehicle on the at least one of the transfer deck and the ramp so that the autonomous transport vehicle roams freely via autonomous navigation, from a first location to a different second location, wherein the first location is a supply of the goods unit, and the second location is a tote fill location based on an order, and a payload connected to the frame for holding the goods unit loaded on the autonomous transport vehicle, the payload having an end effector arranged to extend and unload the goods

### CROSS-REFERENCE TO RELATED APPLICATIONS

This application is a non-provisional of and claims the benefit of U.S. provisional patent application No. 63/452,735 filed on Mar. 17, 2023, the disclosure of which is incorporated herein by reference in its entirety.

### BACKGROUND

### 1. Field

The disclosed embodiment generally relates to material handling systems, and more particularly, to transport and storage of items within the material handling system.

### 2. Brief Description of Related Developments

It is well recognized that integration of automated storage and retrieval systems into a logistic chain, particularly goods to man systems, are highly advantageous throughout efficiency and cost of the logistics chain. Conventional systems, even with a high level of automated storage and retrieval system integration in a logistic facility operate generally by storing product (e.g., supply) containers, where the supply containers include cases, packs, etc. that contain a common type of goods (also referred to as products) in the supply containers. The product containers may arrive on pallets (e.g., of common supply containers) or as truck loads, and are either depalletized or unloaded from trucks, and stored in the logistics facility, distributed throughout the storage volume (e.g., in a three-dimensional array of storage racks) of the logistic facility by the automated storage and retrieval system.

Order fulfillment from the logistic facility, particularly in the event that mixed product containers are desired (e.g., wherein any given order container may have mixed/different products or product types held by a common container such as in cases of direct to consumer fulfillment, or if indirect to consumer, such as via a retail order pick up location, the ordered mix of products in the order container is generated, at least in part, at the logistic facility prior to output from the logistic facility) conventionally, generation of mixed product containers is effected with the automated storage and retrieval system goods to person configuration by the automated storage and retrieval system outputting the product/supply containers (each containing one or more goods items of a common good type, i.e. each goods item in the product container is the same or substantially similar) from storage locations throughout the three-dimensional array of storage racks to workstations, manual or automated, to pick and remove goods from the different product/supply containers, fed by the automated storage and retrieval system to the given workstation, pursuant to a given fulfillment (or fill) order, and to place the different picked goods (mixed or common if a given order is so filled) into order containers. Such workstations may be referred to as breakpack stations, wherein the product container is “broken” down and its contents may be placed in order containers in whole or in part, or into what may be referred to as a breakpack storage container (e.g., totes) such as where the product container is unsuitable for continued holding of remaining product items after the breakpack operation, and such remaining products (i.e., the remainder of products in the “broken” down product container) should be returned to storage in the three-dimensional array of storage racks by the automated storage and retrieval system. The products placed in the order containers are placed loosely within the container by automation such that the product packing within the order container is less than ideal. For example, conventionally the products are placed in the order containers by a conveyor belt/roller system or by a tilting/dumping system where such transfer tends to deposit the products in an area of the order containers closest to the belt/roller conveyor or tilt/dump system, failing to distribute the products evenly within or throughout the order container.

It would be advantageous to have a system that substantially evenly distributes product within order containers. It would also be advantageous to verify distribution of products within the order containers.

### BRIEF DESCRIPTION OF THE DRAWINGS

The foregoing aspects and other features of the disclosed embodiment are explained in the following description, taken in connection with the accompanying drawings, wherein:

FIG. 1 is a schematic illustration of an automated storage and retrieval system in accordance with aspects of the disclosed embodiment;

FIGS. 2A and 2B are schematic illustrations of a goods bot of the automated storage and retrieval system of FIG. 1 in accordance with aspects of the disclosed embodiment;

FIG. 3A is a schematic “exploded” illustration of a portion of the goods bot of FIGS. 2A and 2B in accordance with aspects of the disclosed embodiment;

FIG. 3B is a schematic plan view illustration of an end effector drive system of the goods bot of FIGS. 2A and 2B in accordance with aspects of the disclosed embodiment;

FIGS. 4A and 4B are exemplary schematic illustrations of a payload portion and end effector of the goods bot of FIGS. 2A and 2B in accordance with aspects of the disclosed embodiment;

FIGS. 5A, 5B, and 5C are exemplary schematic illustrations of a payload portion and end effector of the goods bot of FIGS. 2A and 2B in accordance with aspects of the disclosed embodiment;

FIGS. 6A and 6B are exemplary schematic illustrations of a payload portion and end effector of the goods bot of FIGS. 2A and 2B in accordance with aspects of the disclosed embodiment;

FIGS. 7A and 7B are exemplary perspective illustrations of portions of the automated storage and retrieval system of FIG. 1 in accordance with aspects of the disclosed embodiment;

FIG. 8 is an exemplary schematic illustration of a portion of the goods bot of FIGS. 2A and 2B in accordance with aspects of the disclosed embodiment;

FIGS. 9A and 9B are exemplary schematic illustrations of the goods bot of FIG. 8 interfaced with a goods containers in accordance with aspects of the disclosed embodiment;

FIGS. 10A and 10B are exemplary schematic illustrations of the goods bot of FIG. 8 in accordance with aspects of the disclosed embodiment;

FIGS. 11A and 11B are exemplary images generated with sensor data of the goods bot of FIGS. 2A and 2B in accordance with aspects of the disclosed embodiment;

FIGS. 12A-12B are schematic illustrations of a goods transfer effected by the goods bot of FIGS. 4A-4B and 6A-6B in accordance with aspects of the disclosed embodiment;

FIGS. 12C-12D are schematic illustrations of a goods transfer effected by the goods bot of FIGS. 6A-6B in accordance with aspects of the disclosed embodiment;

FIG. 13 is a schematic illustration of a goods transfer effected by the goods bot of FIGS. 5A-5C in accordance with aspects of the disclosed embodiment;

FIGS. 14 and 15 are exemplary illustrations of a goods bot traversing a goods deck in accordance with aspects of the disclosed embodiment; and

FIGS. 16-20 are exemplary flow diagrams of methods in accordance with aspects of the disclosed embodiment.

### DETAILED DESCRIPTION

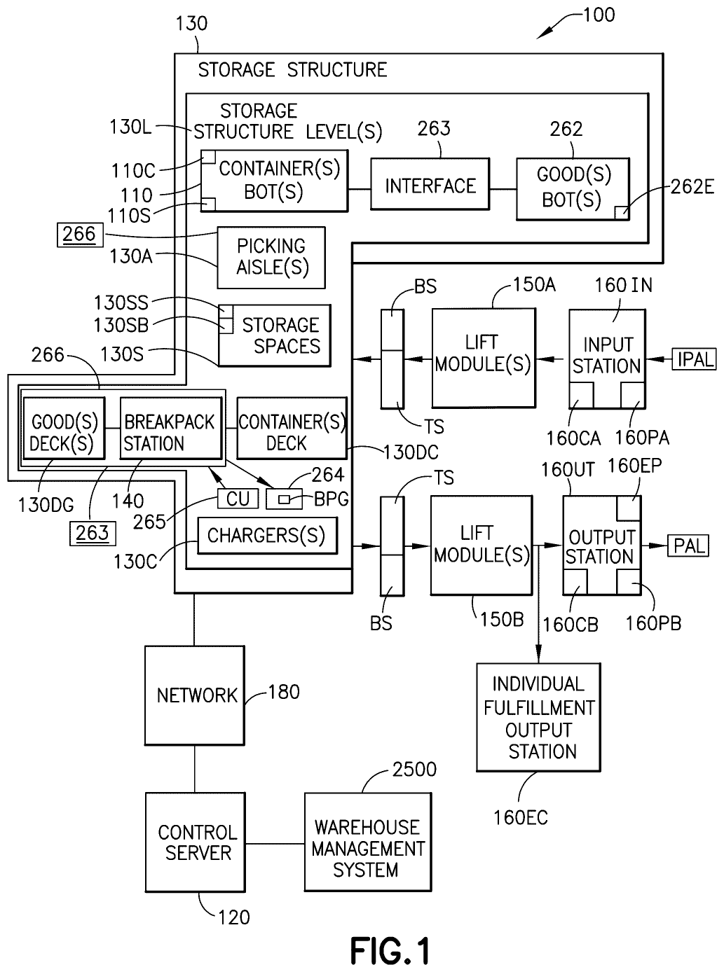

FIG. 1 is a schematic illustration of an automated storage and retrieval system (also referred to herein as a warehousing/warehouse system or product order fulfillment system) 100 in accordance with aspects of the disclosed embodiment. Although the aspects of the disclosed embodiment will be described with reference to the drawings, it should be understood that the aspects of the disclosed embodiment can be embodied in many forms. In addition, any suitable size, shape or type of elements or materials could be used.

In accordance with aspects of the disclosed embodiment the automated storage and retrieval system 100 may operate in a retail distribution center or warehouse to, for example, fulfill orders received from retail stores for case units such as those described in U.S. Pat. No. 10,822,168 issued on Nov. 3, 2020, the disclosure of which is incorporated by reference herein in its entirety. For example, the case units are cases or units of goods not stored in trays, on totes or on pallets (e.g. uncontained). In other examples, the case units are cases or units of goods that are contained in any suitable manner such as in trays, on totes, in containers (such as containers of remainder goods after breakpack where the broken down case unit structure is unsuitable for transport of the remainder goods as a unit) or on pallets. In still other examples, the case units are a combination of uncontained and contained items. It is noted that the case units, for example, include cased units of goods (e.g. case of soup cans, boxes of cereal, etc.) or individual goods that are adapted to be taken off of or placed on a pallet. In accordance with the aspects of the disclosed embodiment, shipping cases for case units (e.g. cartons, barrels, boxes, crates, jugs, or any other suitable device for holding case units) may have variable sizes and may be used to hold case units in shipping and may be configured so they are capable of being palletized for shipping. It is noted that when, for example, bundles or pallets of case units arrive at the storage and retrieval system the content of each pallet may be uniform (e.g. each pallet holds a predetermined number of the same item—one pallet holds soup and another pallet holds cereal) and as pallets leave the storage and retrieval system the pallets may contain any suitable number and combination of different case units (e.g. a mixed pallet where each mixed pallet holds different types of case units—a pallet holds a combination of soup and cereal) that are provided to, for example the palletizer in a sorted arrangement for forming the mixed pallet. In the aspects of the disclosed embodiment, the storage and retrieval system 100 described herein may be applied to any environment in which case units are stored and retrieved.

In accordance with aspects of the disclosed embodiment, orders for filled items (e.g., the pallets, cases, containers, package of goods, individual (unpacked) goods, etc.) may be stochastic (e.g., substantially random in the items ordered and a time the order is received) and may be fulfilled by the automated storage and retrieval system 100 as function of time (e.g., sortation of ordered goods at a predetermined scheduled time in advance of a time the order is to ship/be fulfilled or in a sortation of goods in a just-in-time manner). These stochastic orders are determinative of a pick sequence of sorted items, such as for building a pallet load or pallet PAL (see, e.g., U.S. Pat. No. 8,965,559 titled “Pallet Building System” and issued on Feb. 24, 2015, the disclosure of which is incorporated herein by reference in its entirety). The pallet PAL may include mixed cases, mixed totes, mixed packs, mixed units (or eaches) per tote, etc. Here, the sorted items are picked from a common storage array (e.g., a storage array formed by storage spaces 130S of storage structure 130). The automated storage and retrieval system 100 effects a maximum throughput of goods for each order (e.g., received for processing by the automated storage and retrieval system 100) by employing or otherwise processing the order through one or more of the orthogonal sortation echelons (such as described in, for example, U.S. patent application Ser. No. 17/358,383 filed on Jun. 25, 2021 and titled “Warehousing System for Storing and Retrieving Goods in Containers,” the disclosure of which is incorporated herein by reference in its entirety) to a sortation level needed (e.g., e.g., the controller 120 drills/drives down through the orthogonal sortation echelons to effect the desired level of sortation needed for a given order—a case level sortation, a pack level sortation, a unit/each level sortation or a combination thereof) to effect a given order from the common storage array independent of order type (e.g., a pallet order, a case order, a pack order, mixed orders, etc.), independent of order sequence, and independent of order time.

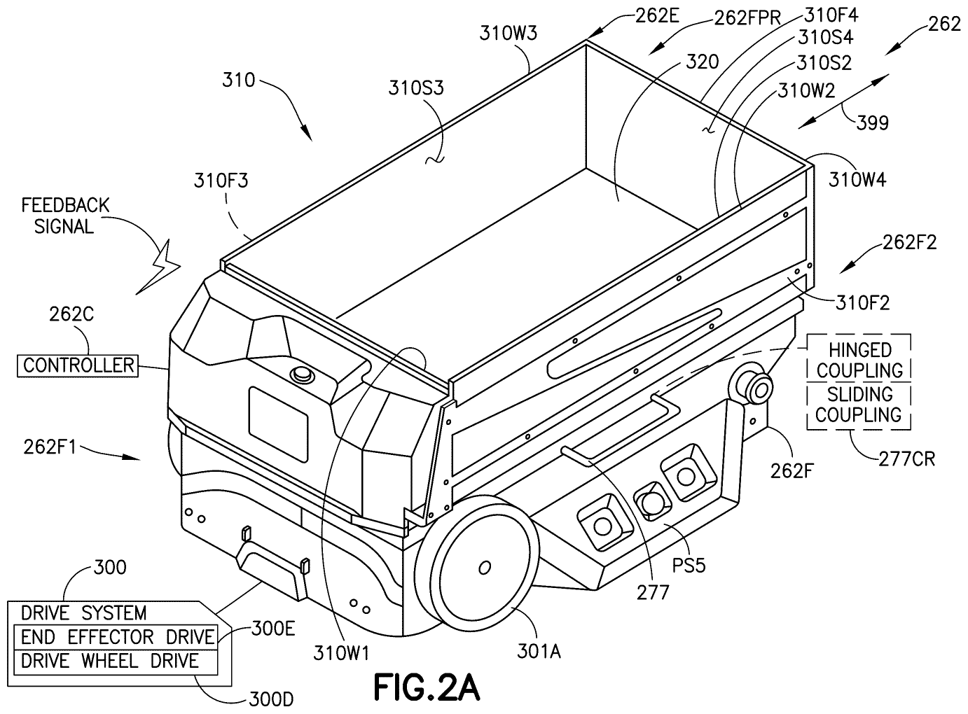

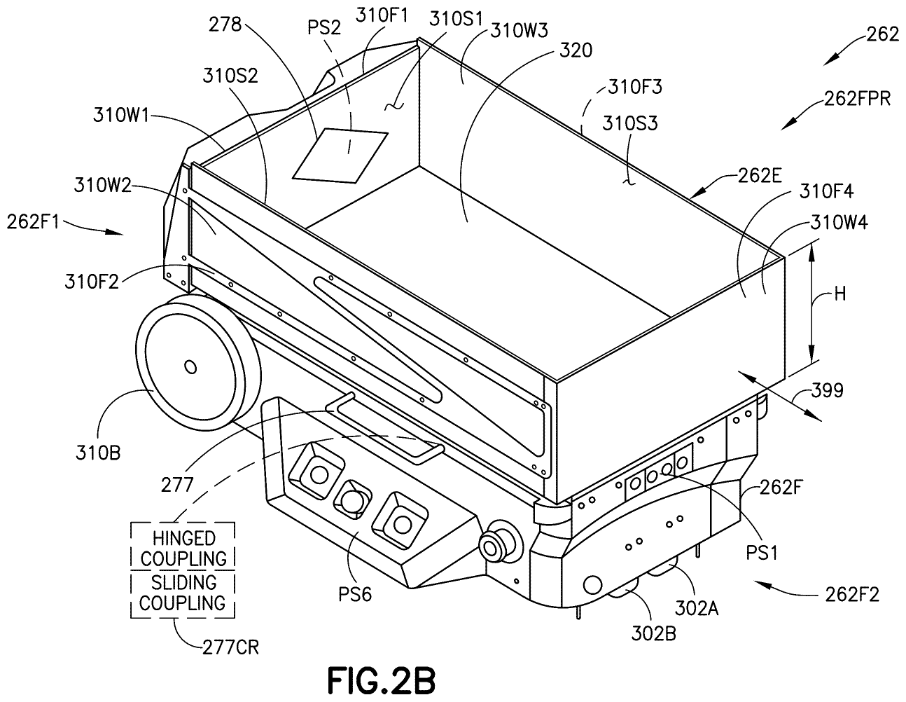

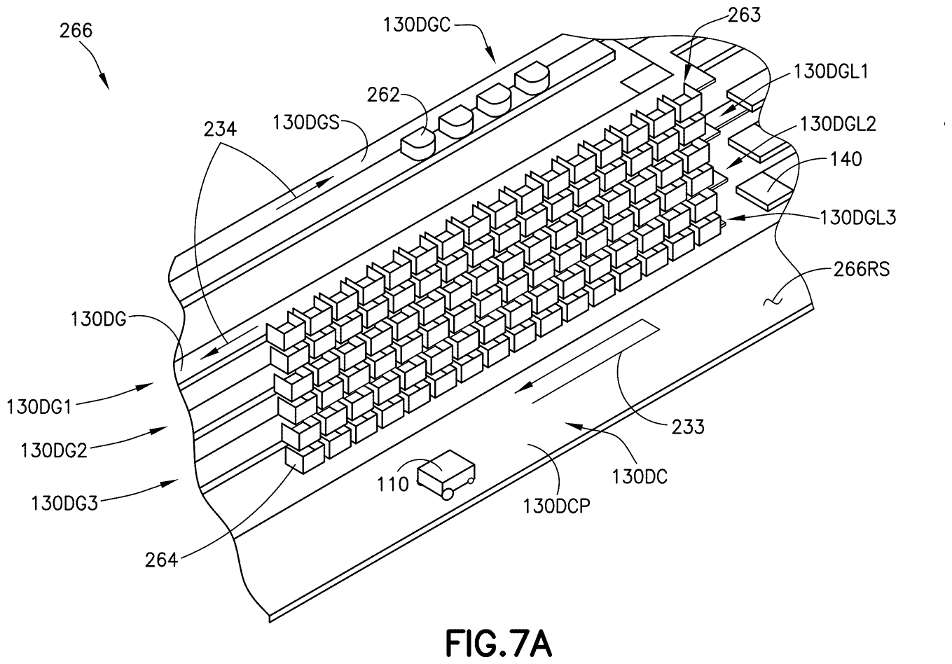

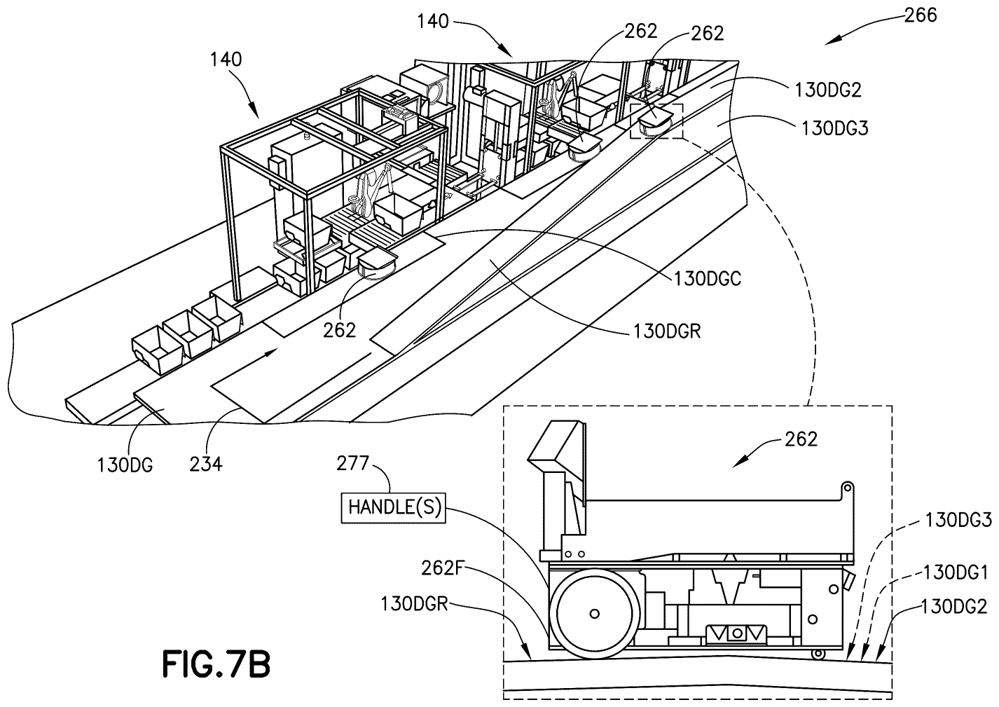

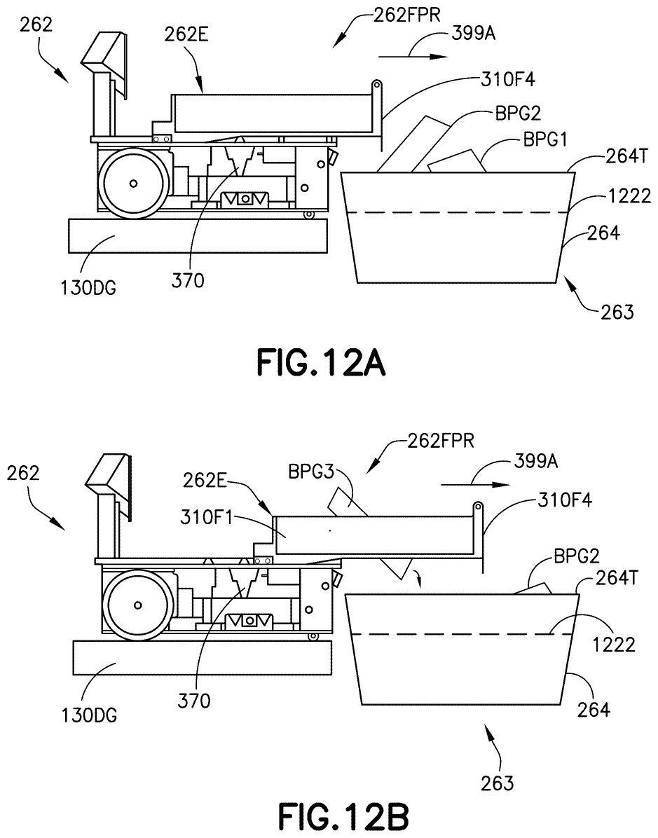

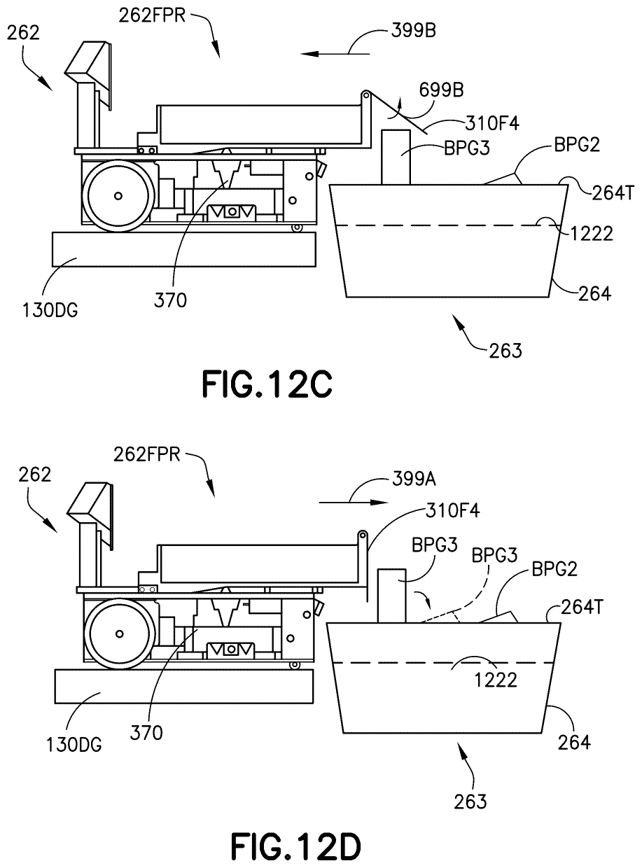

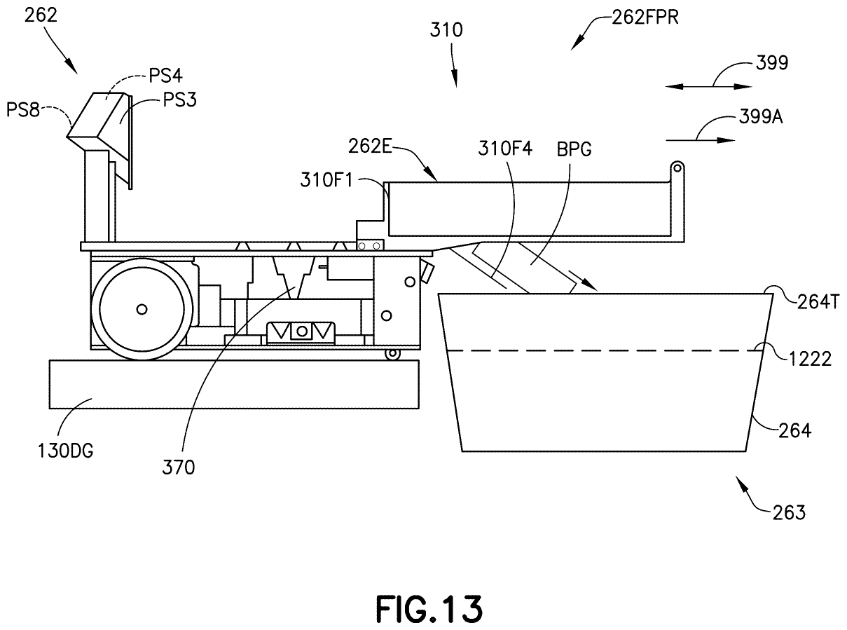

In accordance with the aspects of the disclosed embodiment, the automated storage and retrieval system 100 includes one or more breakpack modules 266. The breakpack module 266 are configured to break down product containers or case units CU into breakpack goods containers 264 (also referred to herein as goods containers or totes for shipping goods) for order fulfillment. Here, product is placed into the breakpack goods containers 264 with automation (such as a goods bot 262 as described herein) such that the products are loosely placed. As described herein, the goods bot 262 includes a payload (also referred to herein as a payload bay or tray) 310 for holding goods unit(s) (also referred to herein as breakpack good (s)) BPG loaded on the goods bot (also referred to herein as an autonomous transport vehicle) 262, where the payload bay 310 has an end effector 262E arranged to extend and unload the breakpack goods BPG from the payload bay 310. The end effector 262E forms a fill placement regulator 262FPR (see, e.g., FIGS. 2A and 2B) that regulates placement of the breakpack goods BPG unloaded in filling a tote or goods container 264 so that each goods container 264 at each goods container fill location (see, e.g., FIG. 7A) is repeatably filled, with tote a fill, substantially to a predetermined fill level 1222 (see FIGS. 12A-12D and 13). The predetermined fill level 1222 may be about 80% filled or any other suitable amount that may be greater or less than 80% filled. The end effector 262E may substantially evenly distribute the product within the breakpack goods containers 264.

In some aspects, the automated storage and retrieval system 100 may include (in addition to or in lieu of the breakpack modules 266) one or more each pick modules substantially similar to those described in U.S. Pat. No. 9,037,286 issued on May 19, 2015 (the disclosure of which is incorporated herein by reference), where the breakpack goods containers 264 are filled by human or robotic operators and output for transport by the container bots 110 for placement in storage or for transfer to an output station 160UT.

A controller 120, as may be realized, of the automated storage and retrieval system 100 is configured to effect operation of a container bot 110 and a goods bot 262 for assembling orders of breakpack goods BPG from supply containers 265 (e.g., case units CU) into breakpack goods containers 264 and outfeed of breakpack goods containers 264 through container outfeed stations TS. For example, the controller 120 is configured to effect operation of the container bot(s) 110 between the container storage locations 130S, a breakpack operation station 140 (of a breakpack module 266), and a breakpack goods container 264 located along a breakpack goods transfer deck 130DG (see also FIGS. 7A and 7B). As another example, the controller 120 is configured to effect operation of the goods bot(s) 262 so that transport of the breakpack goods BPG, by the goods bot 262 traversing the goods transfer deck 130DG, sorts the breakpack goods BPG, e.g., in a unit/each level sortation, to corresponding breakpack goods containers 264 (see also FIG. 7A). As a further example, the controller 120 is configured to effect operation of the container bot(s) 110 (e.g., traversing a container transfer deck 130DC) so that the container bot(s) 110 accesses corresponding breakpack goods containers 264 at the goods transfer deck 130DG and transports the breakpack goods containers 264 via traverse along the container transfer deck 130DC to at least one of a container output/transfer station TS and a corresponding container storage location 130SB of the storage spaces 130S of a corresponding level 130L of a multilevel storage array (i.e., storage structure 130).

It is noted that when, for example, incoming bundles or pallets (also referred to as pallet loads) IPAL (e.g. from manufacturers or suppliers of case units) arrive at the storage and retrieval system 100 for replenishment of the automated storage and retrieval system 100, the content of each pallet IPAL may be uniform (e.g. each pallet holds a predetermined number of the same item—one pallet holds soup and another pallet holds cereal). As may be realized, the cases of such pallet IPAL may be substantially similar or in other words, homogenous cases (e.g. similar dimensions), and may have the same SKU (otherwise, as noted before the pallets may be “rainbow” pallets having layers formed of homogeneous cases). As pallets PAL leave the storage and retrieval system 100, with cases filling customer replenishment orders, the pallets PAL may contain any suitable number and combination of different case units CU (e.g., each pallet may hold different types of case units—a pallet holds a combination of canned soup, cereal, beverage packs, cosmetics and household cleaners). The cases combined onto a single pallet may have different dimensions and/or different SKU's. In one aspect of the disclosed embodiment, the storage and retrieval system 100 may be configured to generally include an in-feed section, a storage and sortation section (where, in one aspect, storage of items is optional), and an output section. As may be realized, in one aspect of the disclosed embodiment the storage and retrieval system 100 operating for example as a retail distribution center may serve to receive uniform pallet loads IPAL of cases, breakdown the pallet goods or disassociate the cases (e.g., at input station 160IN) from the uniform pallet loads into independent case units CU handled individually by the system 100, retrieve and sort the different cases CU sought by each order into corresponding groups, and transport and assemble the corresponding groups of cases (e.g., at the output station 160UT) into what may be referred to as mixed case pallet loads (see pallet load PAL noted above). As may also be realized in one aspect of the disclosed embodiment the system 100 operating for example as a retail distribution center may serve to receive uniform pallet loads IPAL of cases, breakdown the pallet goods or disassociate the cases from the uniform pallet loads (e.g., at the input station 160IN) into independent case units CU handled individually by the system, retrieve and sort the different cases sought by each order into corresponding groups, and transport and sequence the corresponding groups of cases in the manner described in U.S. Pat. No. 9,856,083 issued on Jan. 2, 2018, the disclosure of which is incorporated herein by reference in its entirety.

The storage and sortation section includes, as will be described in greater detail below, a multilevel automated storage system that has an automated transport system that in turn receives or feeds individual cases CU into the multilevel storage array for storage in a storage area (such as storage spaces 130S of the storage structure 130). The storage and sortation section also defines outbound transport of case units from the multilevel storage array such that desired case units are individually retrieved in accordance with commands generated in accordance to orders entered into a warehouse management system, such as warehouse management system 2500, for transport to the output section. In other aspects, the storage and sortation section receives individual cases, sorts the individual cases (utilizing, for example, the buffer and interface stations described herein), e.g., in a case level sortation, and transfers the individual cases to the output section in accordance to orders entered into the warehouse management system. The sorting and grouping of cases according to order (e.g. an order out sequence) may be performed in whole or in part by either the storage and retrieval section or the output section, or both, the boundary between being one of convenience for the description and the sorting and grouping being capable of being performed any number of ways. The intended result is that the output section assembles the appropriate group of ordered cases, that may be different in SKU, dimensions, etc. into mixed case pallet loads in the manner described in, for example, U.S. Pat. No. 8,965,559 issued on Feb. 24, 2015 and titled “Pallet Building System,” the disclosure of which is incorporated herein by reference in its entirety.

In the disclosed embodiment, the output section generates the pallet load in what may be referred to as a structured architecture of mixed case stacks. The structured architecture of the pallet load described herein is representative and in other aspects, the pallet load may have any other suitable configuration. For example, the structured architecture may be any suitable predetermined configuration such as a truck bay load or other suitable container or load container envelope holding a structural load. The structured architecture of the pallet load may be characterized as having several flat case layers as described in U.S. Pat. No. 9,856,083, the disclosure of which is incorporated by reference herein in its entirety.

In accordance with aspects of the disclosed embodiment, still referring again to FIG. 1, the automated storage and retrieval system 100 includes a storage array (e.g., storage structure 130 having storage spaces 130S) with at least one elevated storage level 130L (where more than one elevated storage levels forms storage racks of stacked storage levels). Mixed product units are input and distributed in the storage array in cases CU of product units of common kind per case CU (each case input to the system 100 holds a common kind of stock keeping unit (SKU)). For example, the automated storage and retrieval system 100 includes input stations 160IN (which include depalletizers 160PA and/or conveyors 160CA for transporting items (e.g., inbound supply containers) to lift modules (or lifts) 150A for entry into a storage level 130L of the storage structure 130).

As will be described herein, the automated storage and retrieval system 100 includes an automated transport system (e.g., bots, breakpack stations, and other suitable level transports described herein) with at least one asynchronous transport system for transporting cases/products on a given storage structure level 130L (e.g., level transport). The storage and retrieval system 100 includes undeterministic container bots 110 that travel along one or more physical pathways of the storage and retrieval system (e.g., such as one or more of the picking aisles 130A and container transfer deck 130DC) to provide at least one level of asynchronicity. The container bots 110 may be any suitable independently operable autonomous transport vehicles that carry and transfer case units along the X and Y throughput axes throughout the storage and retrieval system 100. In one aspect the container bots 110 are automated, independent (e.g. free riding) autonomous transport vehicles. Suitable examples of bots can be found in, for exemplary purposes only, U.S. Pat. No. 10,822,168 issued on Nov. 3, 2020; U.S. Pat. No. 8,425,173 issued on Apr. 23, 2013; U.S. Pat. No. 9,561,905 issued on Feb. 7, 2017; U.S. Pat. No. 8,965,619 issued on Feb. 24, 2015; U.S. Pat. No. 8,696,010 issued on Apr. 15, 2014; U.S. Pat. No. 9,187,244 issued on Nov. 17, 2015; U.S. Pat. No. 11,078,017 issued on Aug. 3, 2021; U.S. Pat. No. 9,499,338 issued on Nov. 22, 2016; U.S. Pat. No. 10,894,663 issued on Jan. 19, 2021; and U.S. Pat. No. 9,850,079 issued on Dec. 26, 2017, the disclosures of which are incorporated by reference herein in their entireties. The container bots 110 may be configured to place case units, such as the above described retail merchandise, into picking stock in the one or more levels of the storage structure 130 and then selectively retrieve ordered case units.

At least another level of asynchronicity is provided (as described herein) such that, for example, case/product holding locations are greater than the number of bots transporting cases/products. At least one lift module (or lift) 150B is provided for transporting cases/products between storage levels 130L (e.g., between level transport). The at least one lift 150B is communicably connected to the storage array (e.g., formed by the storage spaces 130S of the storage level(s) 130L) so as to automatically retrieve and output, from the storage array, product units distributed in the cases CU in a common part (e.g., the storage locations 130S of a respective storage level 130L) of the at least one elevated storage level 130L of the storage array. The output product units being one or more of mixed singulated product units, in mixed packed groups, and in mixed cases. As an example, the automated storage and retrieval system 100 includes output stations 160UT, 160EC (which include palletizers 160PB, operator stations 160EP and/or conveyors 160CB for transporting items (e.g., outbound supply containers and filled breakpack goods (order) containers) from lift modules 150B for removal from storage (e.g., to a palletizer (for palletizer load) or to a truck (for truck load)). Here the output station 160EC is an individual fulfillment (or e-commerce) output station where, for example, filled breakpack goods (order) containers including single goods items and/or small bunches of goods are transported for fulfilling an individual fulfillment order (such as an order placed over the Internet by a consumer). The output station 160UT is a commercial output station where large numbers of goods are generally provided on pallets for fulfilling orders from commercial entities (e.g., commercial stores, warehouse clubs, restaurants, etc.). As may be realized, the automated storage and retrieval system 100 includes both the commercial output station 160UT and the individual fulfillment output station 160EC; while in other aspects, the automated storage and retrieval system includes one or more of the commercial output station 160UT and the individual fulfillment output station 160EC.

The automated storage and retrieval system 100 also includes the input and output vertical lift modules 150A, 150B (generally referred to as lift modules 150—it is noted that while input and output lift modules are shown, a single lift module may be used to both input and remove case units from the storage structure), a storage structure 130 (which may have at least one elevated storage level as noted above and in some aspects, forms a multilevel storage array), and at least one autonomous container transport vehicle 110 (referred to herein as “container bots” or “autonomous guided vehicles” and which form at least a part of the asynchronous transport system for level transport) which may be confined to a respective storage level of the storage structure 130 and are distinct from a transfer deck 130DC on which they travel. It is noted that the depalletizers 160PA may be configured to remove case units from pallets so that the input station 160IN can transport the items to the lift modules 150 for input into the storage structure 130. The palletizers 160PB may be configured to place items removed from the storage structure 130 on pallets PAL for shipping. As used herein the lift modules 150, storage structure 130 and container bots 110 may be collectively referred to herein as the multilevel automated storage system (e.g. storage and sorting section) noted above, which has an integral “on the fly sortation” (e.g. sortation of case units during transport of the case units) so that case unit sorting and throughput occurs substantially simultaneously without dedicated sorters as described in U.S. Pat. No. 9,856,083, previously incorporated herein by reference in its entirety.

Referring to FIGS. 1 and 7A, the storage structure 130 may include a container autonomous transport travel loop(s) 233 (e.g., formed on and along a container transfer deck 130DC) disposed at a respective level of the storage structure 130. The containers bots 110 travel along the container autonomous transport travel loop(s) 233 for transporting supply containers 265 to the breakpack module 266 and for retrieving breakpack goods containers 264 from the breakpack module 266 in a manner similar to that described in U.S. patent application Ser. No. 17/358,383 filed on Jun. 25, 2021 (titled “Warehousing System for Storing and Retrieving Goods in Containers”) and Ser. No. 17/657,705 filed on Apr. 1, 2022 (titled “Warehousing System for Storing and Retrieving Goods in Containers”), the disclosures of which are incorporated herein by reference in their entireties.

It is noted that the lifts 150 are connected via transfer stations TS (also referred to herein as container infeed stations when the lift 150 is an inbound lift 150A or as container outfeed stations when the lift 150 is an outbound lift 150B) to the container transfer deck 130DC, and each lift is configured to lift one or both of supply containers 265 (empty or filled) and the breakpack goods containers 264 (empty or filled) into and out of the at least one elevated storage level 130L of the storage structure 130. Container storage locations (or spaces) 130S are arrayed peripherally along the container transfer deck 130DC and/or picking aisles 130A such as described in U.S. Pat. No. 9,856,083, previously incorporated by reference herein in its entirety and U.S. Pat. No. 10,822,168 issued on Nov. 3, 2020, the disclosure of which is incorporated herein by reference in its entirety.

The container transfer decks 130DC are substantially open and configured for the undeterministic traversal of container bots 110 along multiple travel lanes across and along the container transfer decks 130DC. As described in U.S. Pat. No. 10,556,743 issued on Feb. 11, 2020 and having application Ser. No. 15/671,591 (the disclosure of which is incorporated herein by reference in its entirety) the multiple travel lanes may be configured to provide multiple access paths or routes to each storage location 130S (e.g., pickface, case unit, container, or other items stored on the storage shelves) so that container bots 110 may reach each storage location using, for example, a secondary path if a primary path to the storage location is obstructed. As may be realized, the container transfer deck(s) 130DC at each storage level 130L communicate with each of the picking aisles 130A on the respective storage level 130L.

Still referring again to FIG. 1, each storage level 130L may also include charging stations 130C for charging an on-board power supply of the container bots 110 on that storage level 130L such as described in, for example, U.S. patent application Ser. No. 14/209,086 filed on Mar. 13, 2014 and U.S. Pat. No. 9,082,112 issued on Jul. 14, 2015, the disclosures of which are incorporated herein by reference in their entireties.

Referring again to FIGS. 1, 7A, and 7B, one or more of the breakpack modules 266 may be disposed in a picking aisle (s) 130A or accessed from the container transport deck 130DC such as described in U.S. patent application Ser. No. 17/358,383 filed on Jun. 25, 2021 (titled “Warehousing System for Storing and Retrieving Goods in Containers”) and Ser. No. 17/657,705 filed on Apr. 1, 2022 (titled “Warehousing System for Storing and Retrieving Goods in Containers”), the disclosures of which were previously incorporated herein by reference in their entireties.

Each of the one or more break pack modules 266 has a container bot riding surface 266RS that forms a portion 130DCP of the container transfer deck 130DC, where the riding surface 266RS is substantially similar to that of container transfer deck 130DC (e.g., open and undeterministic), while in other aspects, the container bot riding surface 266RS may be substantially similar to that of the picking aisles 130A (e.g., rail guided). For ease of explanation, the aspects of the disclosed embodiment will refer to the container bot riding surface 266RS within the breakpack module 266 as a portion of the container transfer deck 130DC. In aspects where the bot riding surface 266RS is formed by a portion of (or is an extension of) the container transfer deck 130DC it is noted that the transport loop of the breakpack module 266 may be a multilane transport loop.

Each of the breakpack modules 266 includes a breakpack goods autonomous transport travel loop 234 (e.g., formed on and along a goods deck or goods transfer deck 130DG), at least one breakpack operation station 140 (configured so that one or more breakpack goods BPG are, manually or with automation, unpacked from supply container(s) 265 and loaded onto a goods bot 262 at the breakpack operation station 140), and a breakpack goods interface 263 disposed between and interfacing the goods transfer deck 130DG with the container transfer deck 130DC. As can be seen in FIG. 7A, the container bot travel surface 266RS of the breakpack module 266 forms a travel loop 233 around which the container bots 110 travel to respectively transport, along the container bot travel surface 266RS travel loop 233, a supply container (e.g., case unit, pickface, remainder container, etc.) between the storage locations 130S and a breakpack operation station 140 (and/or vice versa), and a breakpack goods container (also referred to as a breakpack goods container) 264 between the breakpack goods interface 263 and the breakpack goods container storage location 130SB or a lift 150B (and/or vice versa). The travel loop 233 provides the container bot 110 with random access to any and each breakpack goods interface locations 263L of the breakpack goods interface 263 along the bot travel surface 266RS, where the breakpack goods interface locations 263L form an asynchronous product distribution system.

The goods transfer deck 130DG forms a goods autonomous transport travel loop 234 disposed at the storage level 130L. The goods transfer deck 130DG is separate and distinct from the travel loop 233 formed by the container bot travel surface 266RS, and has the breakpack goods interface 263 coupling respective edges of the container autonomous transport travel loop 233 of the container transfer deck 130DC and the breakpack goods autonomous transport travel loop 234 of the goods transfer deck 130DG. The goods autonomous transport travel loop 234 formed by the goods transfer deck 130DG is disposed on a deck surface 130DGS of a deck (e.g., goods transfer deck 130DG) at a respective storage level 130L, and the breakpack goods autonomous transport travel loop(s) 234 of the goods transfer deck 130DG is disposed on a different deck surface 130DGS, separate and distinct from the deck surface of the container bot travel surface 266RS (formed by the container transfer deck 130DC and/or rails of a picking aisle 130A) where the container autonomous transport travel loop 233 is disposed. The breakpack goods autonomous transport travel loop 234 formed by the goods transfer deck 130DG (and hence the goods transfer deck 130DG) is disposed to confine at least one autonomous breakpack goods transport vehicle (also referred to as goods bots, or goods transport vehicles) 262 to the respective storage level 130L. In one aspect, as illustrated in FIGS. 7A and 7B, one or more of the breakpack modules 266 includes two or more (i.e., multiple levels) goods transfer decks 130DG1-130DG3 stacked one above the other where the goods transfer decks 130DG1-130DG3 are communicably connected to each other by one or more ramps 130DGR, where the ramp(s) 130DGR may form a part of the breakpack goods autonomous travel loop(s) 234; however, in other aspects the breakpack module(s) may have a single level where an elevated level of at least one breakpack module is connected to a container transfer deck level. The breakpack goods interface 263 may be in the form of one or more racks and include multilevel levels 130DGL1-130DGL3 that are each accessible from a common (level) container transfer deck 130DC.

The at least one goods bot 262 is arranged or otherwise configured for transporting, along the breakpack goods autonomous transport travel loop 234 formed at least by the goods transfer deck 130DG, one or more breakpack goods BPG (e.g., a pack that is unpacked from the supply container in a pack level sort or a unit/each unpacked from a pack in a unit/each level sort) between the breakpack operation station 140 and the breakpack goods interface 263. The container bot(s) 110 is also configured to autonomously pick and place the breakpack goods containers 264 at the breakpack goods interface 263. The breakpack goods interface 263 may be substantially similar to one or more of the transfer stations TS and buffer stations BS and include an undeterministic surface (similar to that of the rack storage spaces 130S) upon which breakpack goods containers 264 are placed so as to form an undeterministic interface between the goods transfer deck 130DG and the container transfer deck 130DC.

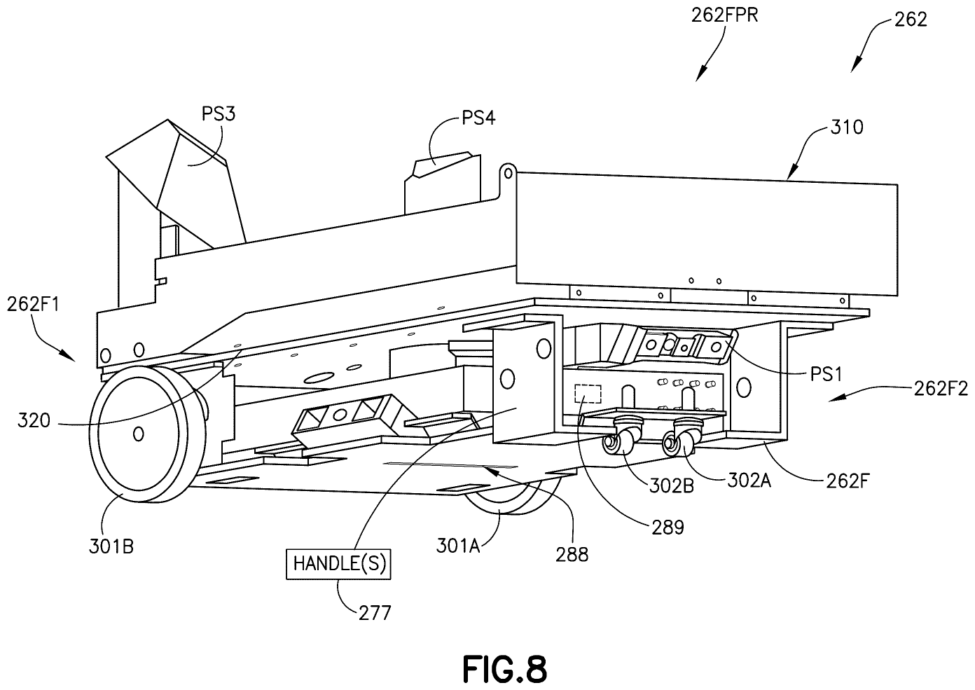

Referring to FIGS. 2A, 2B, and 8, the goods bots 262 may be any suitable type of autonomously guided bot or vehicle with a payload configured for holding breakpack goods BPG (e.g., received from the breakpack operation station 140), not product containers (e.g., case units, pickfaces, etc.). The goods bots 262 are configured so as to automatically unload one or more breakpack goods BPG (retrieved from the breakpack operation station 140) from the goods bot 262 to breakpack goods containers 264 at the breakpack goods interface 263. The goods bot 262 includes a frame 262F, a drive system 300 coupled to the frame 262F, and a payload bay 310 coupled to the frame 262F.

The frame 262F is configured so that the goods bot 262 traverses, as a unit, on at least one of a transfer deck (such as the goods deck 130DG) and a ramp 130DGR. The frame 262F includes one or more handles 277 that effect porting (carrying transport) of the goods bot 262 by a human operator or automated handling equipment. Each handle 277 is shaped and sized so that a human operator grips the handle 277 for lifting the goods bot 262. Each handle 277 may be coupled to the frame 262F in any suitable manner. For example, the handle(s) 277 may be fixed to the frame with any suitable mechanical or chemical fasteners (e.g., welding, brazing, bolts, etc.). In other aspects, the handle(s) 277 may be removably coupled to the frame 277 so as to be attached to the frame 262F for porting the goods bot 262 and detached from the frame 262F for operation of the goods bot 262 within the storage and retrieval system 100. In still other aspects, the handle(s) 277 may be movably coupled to the frame with a retractable coupling 277CR so as to move from a retracted configuration (such as folded against the frame 262F such as on a hinged coupling or inserted at least partially into the frame 262F such as on a sliding coupling) to a deployed configuration (such as unfolded relative to the frame 262F such as on the hinged coupling or removed at least partially from the frame 262F such as on the sliding coupling).

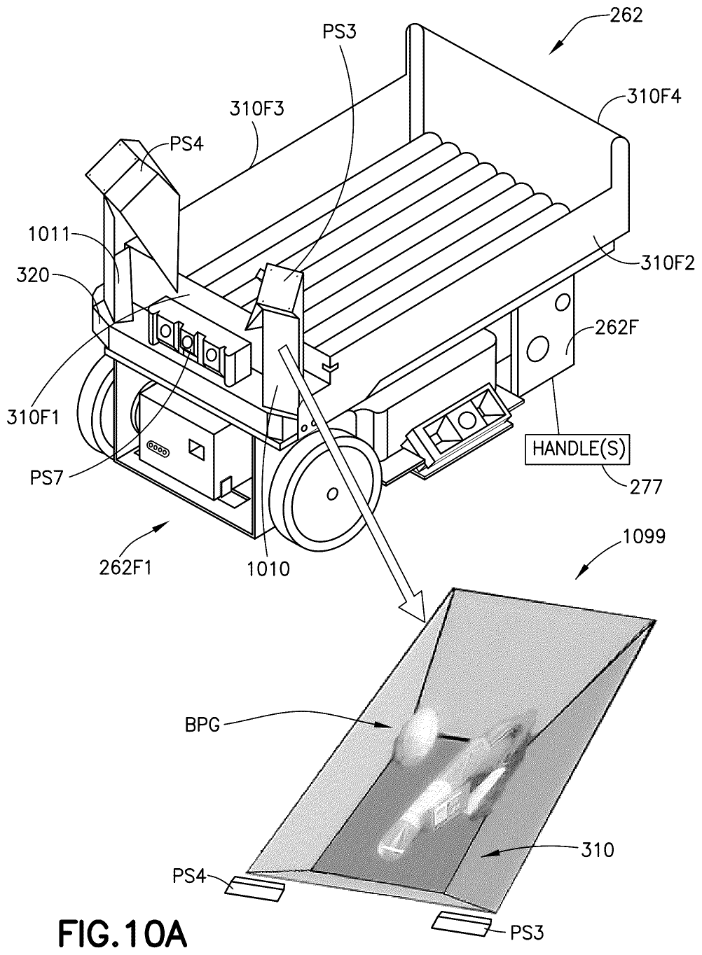

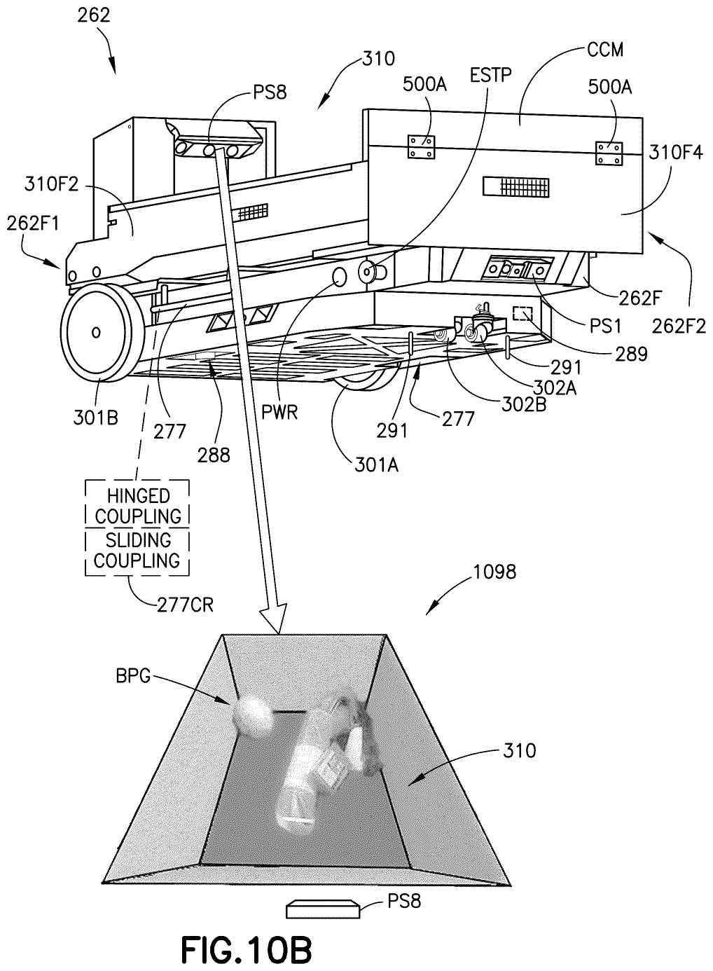

The frame may also include any suitable charging ports 288 for effecting charging any suitable power source 289 onboard the goods bot 262 (see, e.g., FIGS. 8 and 10B). The charging ports may be configured as inductive ports or contact ports for coupling with any suitable charger disposed at a charging location 130DGC of the goods deck 130DG. The charging location(s) 130DGC may be disposed at any suitable location on the goods deck 130DG such that charging of the goods bot 262 occurs during breakpack goods transfer (such as adjacent a container 264 at the interface 263 and/or at a breakpack station 140) to and/or from the goods bot 262 or at any other location of the goods deck 130DG. The frame 262F may include any suitable electrostatic grounding features 291 (see FIG. 10B) such as rods, springs, etc. Any suitable power switches PWR and emergency stop buttons ESTP may be mounted to the frame at any suitable locations for energizing and de-energizing the electronics of the goods bot 262.

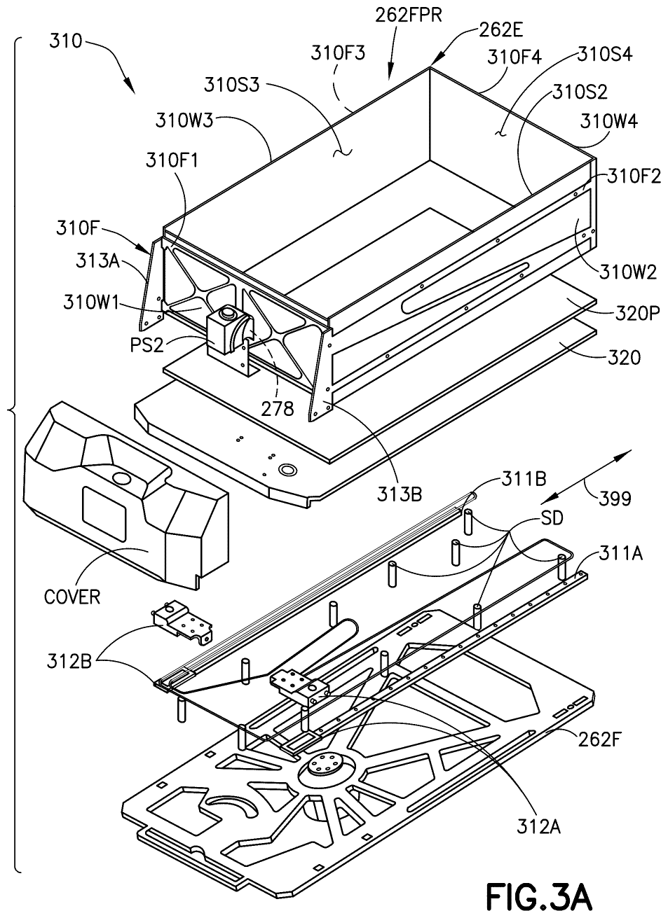

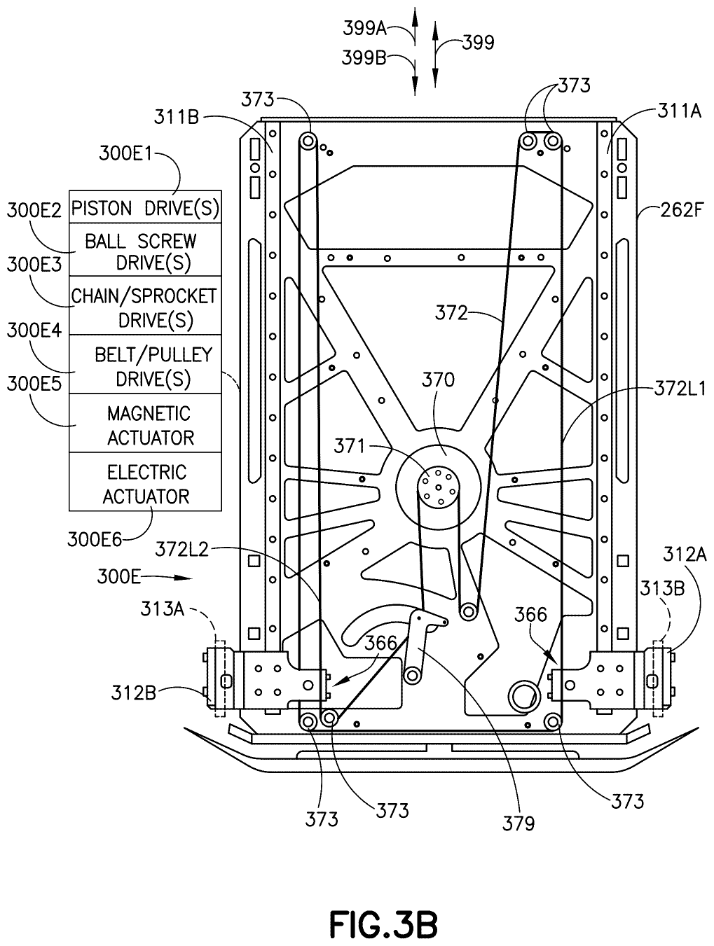

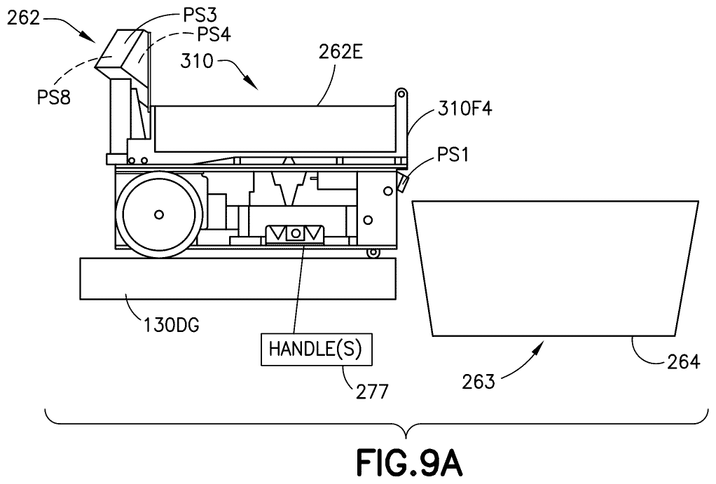

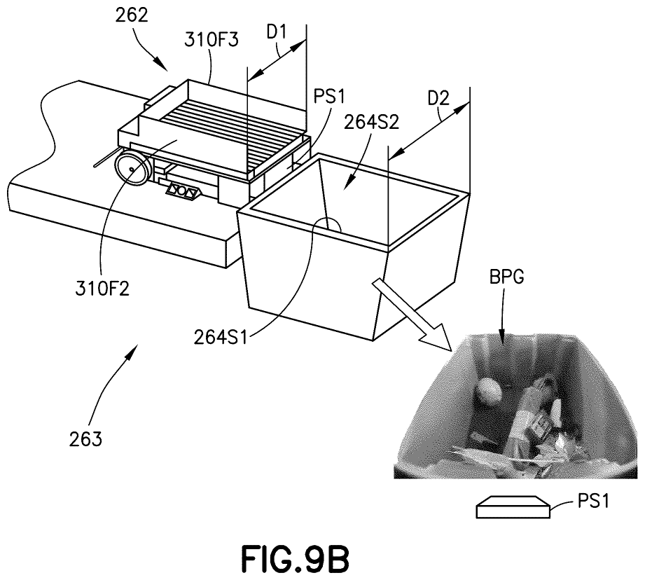

A controller 262C is connected to the frame 262F and is configured (via any suitable non-transitory computer readable code including, which may include but is not limited to neural networks) to effect movement of the goods bot 262 on the at least one of the goods deck 130DG and the ramp 130DGR so that the goods bot 262 roams freely via autonomous navigation, from a first location to a different second location, wherein the first location is a supply of the goods unit (such as a breakpack station 140), and the second location is a tote fill location (such as at interface 263—see FIGS. 7A, 9A and 9B) based on an order. For example, a pair of drive wheels 301A, 301B are coupled to the frame 262F, adjacent one end 262F1 of the frame 262F, and are driven by a drive wheel drive 300D of the drive system 300. The drive wheel drive 300D is operated under control of any suitable controller 262C (see FIG. 2A) of the goods bot 262 to effect transfer of breakpack goods BPG in the manner described herein. The drive wheel drive 300D may be any suitable drive such as a direct drive motors coupled to respective wheels 301A, 301B or any other suitable drive (s) employing any suitable transmission for imparting rotation to one or more of the wheels 301A, 301B (e.g., independent rotation of each wheel and/or differential rotation of the wheels). At least one caster wheel 302A, 302B is coupled to the frame 262F adjacent another end of the frame 262F2 opposite the end 262F1 (in other aspects the wheels 302A, 302B may be steerable wheels). The drive wheels 301A, 301B and the at least one caster wheel 302A, 302B support the frame 262F for traverse of the goods bot 262 on and along the goods deck 130DG (see FIGS. 1, 7A, and 7B). The goods bot 262 may include any suitable covers (see e.g., FIGS. 2A, 2B, and 3A) for covering one or more components of the goods bot 262.

The payload bay or payload 310 is connected to the frame 262F for holding the breakpack goods BPG loaded on the goods bot 262, where the payload bay 310 has an end effector 262E arranged to extend and unload the breakpack goods BPG from the payload bay 310. The end effector 262E forms a fill placement regulator 262FPR that regulates placement of the breakpack goods BPG unloaded in filling the breakpack goods container 264 so that each breakpack goods container 264 at each tote fill location (see the interface 263 in FIG. 7A) is repeatably filled, with a tote fill, substantially to the predetermined fill level 1222 (see FIGS. 12A-12D and 13). The fill placement regulator 262FPR regulates each tote fill substantially agnostic with respect to size, shape and quantity of each goods unit BPG in the tote fill of a common breakpack goods container 264. Here, agnostic means regardless of the shape and size of each breakpack good BPG and the quantity and/or type of the breakpack good BPG, that so long as the packing rules accept the breakpack good BPG to be packed together in the common breakpack goods container 264.

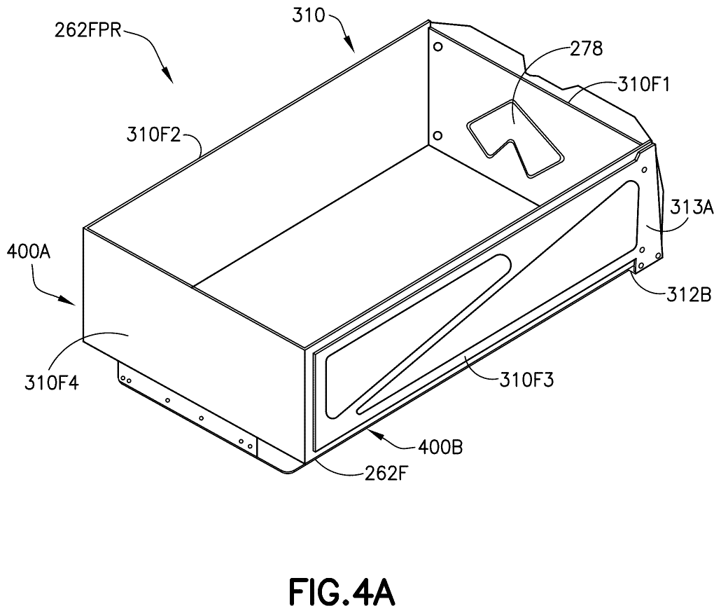

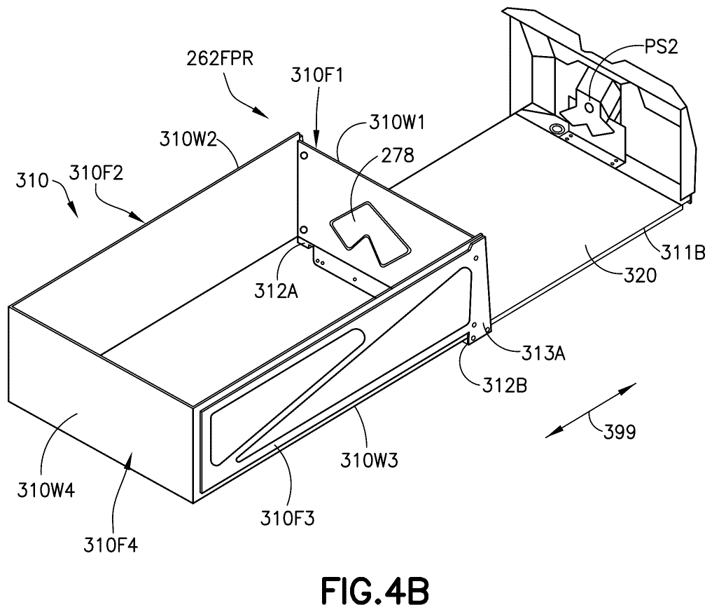

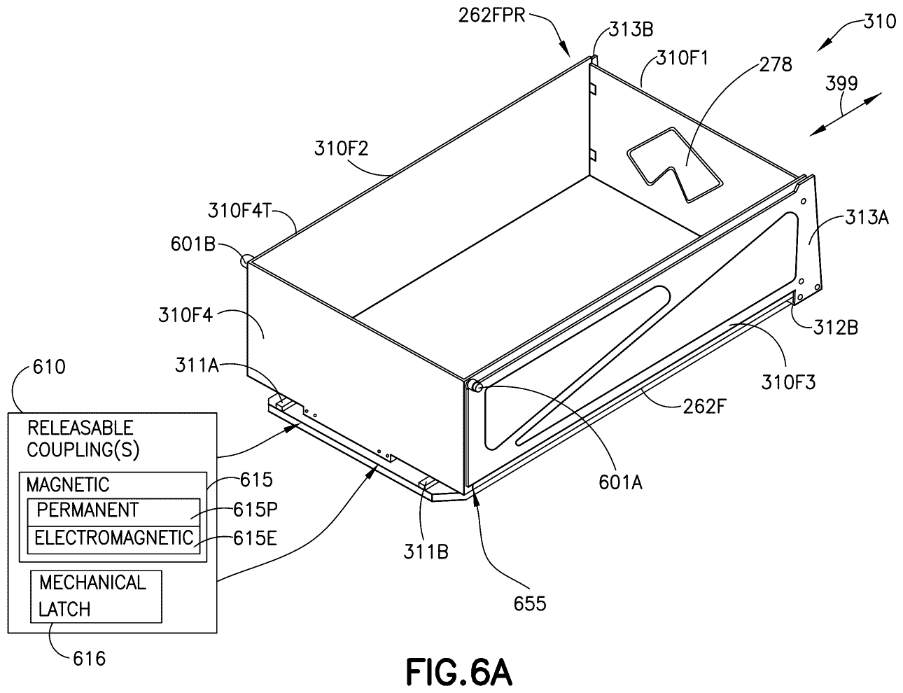

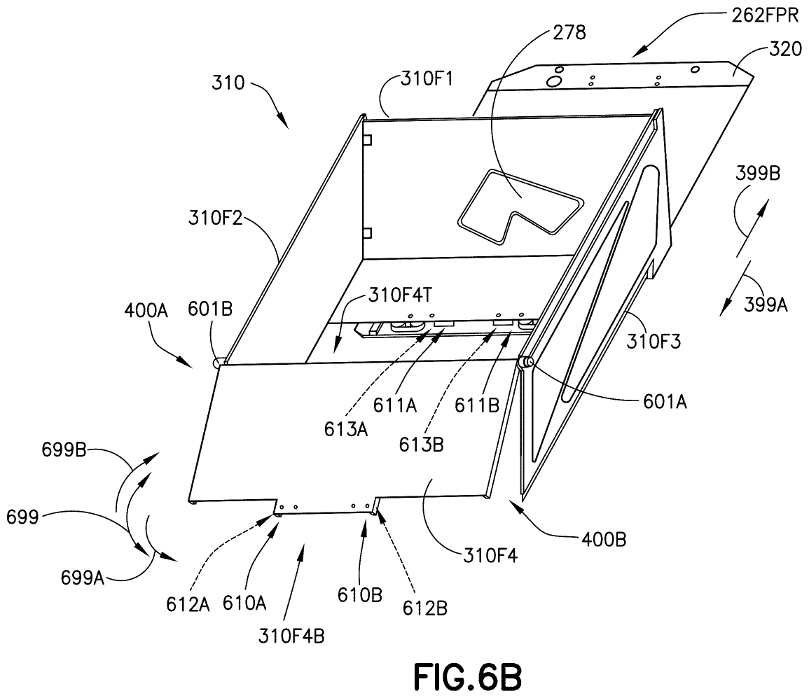

The payload bay 310 includes, and is formed by, a payload support 320 and an end effector 325. The payload support 320 is coupled to the frame 262F in any suitable manner so as to be stationary relative to the frame 262F. The payload support 320 is illustrated as having a planar structure but may have any suitable configuration for supporting the breakpack goods BPG within the payload bay 310. The payload support 320 may include any suitable pad 320P (see FIG. 3A) thereon where the pad may have resilient and/or anti-friction properties to facilitate cushioning and/or unloading breakpack goods BPG transferred by the goods bot 262. As described herein, the end effector 262E has at least one side wall 310W1-310W4 containing the payload (e.g., one or more breakpack goods BPG) held by the goods bot 262. The end effector 262E extends from a closed location (as illustrated in, e.g., FIGS. 2A, 2B, 4A, 5A, 6A) to an open extended position (as illustrated in, e.g., FIGS. 4B, 5C, 6B, 12B, and 13). The end effector 262E has a justification feature (e.g., at least side wall 310W1 or the portions of the payload bay 310 that form the side wall 310W1) that contacts the breakpack goods BPG so as to offload (e.g., push or release) the breakpack goods BPG that unloads the breakpack goods BPG from the payload bay 310. The end effector 262E may also have a justification feature (e.g., at least side wall 310W4 or the portions of the payload bay 310 that form the side wall 310W4) that is disposed so as to the tote fill (e.g., relative to the breakpack goods container 264 and any breakpack goods BPG therein), and bias breakpack goods BPG of the tote fill during extension or retraction of the end effector 262E, so as to regulate the tote fill of each breakpack goods container 264 substantially to the repeatable fill level 1222 (as illustrated and described herein with respect to, e.g., at least FIGS. 12A-12D and 13). The fill placement regulator 262FPR, of the end effector 262E, effects repeatably retraction of the end effector 262 to the closed position at each placement of the breakpack goods BPG independent of obstruction from the tote fill at each placement. In one or more aspects, the end effector 262 has a movable wall 310W4 (see, e.g., FIGS. 6A, 6B, 12C, and 12D), that moves (e.g., passively through contact with breakpack goods BPG in the breakpack goods container 264) with retraction of the end effector so as to clear each tote fill obstruction; while in other aspects, the wall 310W4 may be moved actively under impetus of any suitable actuators of the end effector that are configured to drive movement the wall 310W4, independent of end effector retraction, so as to clear each tote fill obstruction.

Referring to FIGS. 2A, 2B, 3A, and 3B, the end effector 325 forms perimeter walls of the payload bay that extend away from the payload support 320 any suitable distance or height H (FIG. 2B) so as to substantially contain the breakpack goods within the payload bay 310. The end effector 325 includes a frame that is movably coupled to the frame 262F (a portion of which is illustrated in FIG. 3A) in any suitable manner, such as on a slide. For example, one or more rails 311A, 311B are coupled to the frame 262F to effect extension and retraction of the end effector 262E in direction 399, along the rails 311A, 311B as will be described herein. In one aspect, the rails 311A, 311B and are positioned on the frame 262F to straddle the payload support 320; while in other aspects, the rails 311A, 311B are disposed between the payload support 320 and the frame 262F, where the payload support includes slots through which the frame 310F is movable coupled to the rails 311A, 311B; while in still other aspects, the payload support 320 is coupled to the frame 262F through spacers/stanchions SD (see FIG. 3A) so as to be spaced from frame by any suitable distance that allows for coupling of and operation of the sliders 312A, 312B (which extend transverse to direction 399 beyond the support tray for coupling with the stanchions 313A, 313B) to and along the rails 311A, 311B. Sliders 312A, 312B (illustrated in an “exploded” view in FIG. 3A) are movably coupled to a respective one of the rails 311A, 311B so as to slide back and forth (e.g., reciprocate) along the respective rail 311A, 311B in direction 399.

The frame includes stanchions 313A, 313B that are coupled to the sliders 312A, 312B. For example, stanchion 313A is coupled to slider 312A so that the stanchion 313A and slider 312A move as a unit along the rail 311A. Stanchion 313B is coupled to slider 312B so that the stanchion 313B and slider 312B move as a unit along the rail 311B. As illustrated in FIG. 3A, the stanchions 313A, 313B are disposed at one end of the frame 310F so that the end effector 262E is substantially cantilevered from the stanchions 313A, 313B. For example, frame member 310F1 is coupled to and spans between the stanchions 313A, 313B and includes goods engagement surface 310S1 that forms an end wall 310W1 of the payload bay 310. Frame member 310F2 is coupled to stanchion 313B, is cantilevered from the stanchion 313B, and extends in direction 399. The frame member 310F2 includes goods engagement surface 310S2 that forms a side wall 310W2 of the payload bay 310. Frame member 310F3 (which is similar to frame member 310F2) is coupled to stanchion 313A, is cantilevered from the stanchion 313A, and extends in direction 399. The frame member 310F3 includes goods engagement surface 310S3 that forms side wall 310W3 of the payload bay 310 that is opposite the side wall formed by goods engagement surface 310S2. Frame member 310F4, which includes goods engagement surface 310S4, spans between and is coupled to the side frame members 310F2, 310F3 (as will be described herein) to form another end wall 310W4 of the payload bay 310, opposite the end wall 310W1 formed by frame member 310F1. Here, with the end effector 262E in a retracted position (as illustrated in FIGS. 2A and 2B) breakpack goods BPG within the payload bay 310 are supported by the payload support 320 and contained by the goods engagement surfaces 310S1-310S4 that form a containment perimeter around the payload support 320.

The end effector 262E is driven between the retracted position (as illustrated in, e.g., FIGS. 2A, 2B, 4A, 5A, and 6A) and an extended or partially extended position (as illustrated in, e.g., FIGS. 4B, 5C, and 6B) by the end effector drive 300E. Referring to FIGS. 3A and 3B an exemplary end effector drive 300E is illustrated; however, the end effector drive 300E may have any suitable configuration (e.g., including one or more of piston drive(s) 300E1, ball-screw drive(s) 300E2, chain and sprocket drive(s) 300E3, belt and pulley drive(s) 300E4, magnetic actuators 300E5 and/or electric actuator(s) 300E6, etc.) for driving the end effector in direction 399 between the retracted and extended positions. In the example illustrated in FIGS. 3A and 3B, the end effector drive 300E includes a rotary motor 370 that drives a pulley 371 (e.g., the pulley 371 is coupled to an output of the rotary motor 370 in any suitable manner). The pulley 371 in turn drives a serpentine belt 372 that is wrapped around multiple idler pulleys 373. The idler pulleys 373 provide for a belt transport path that includes two belt legs 372L1, 372L2 that travel in the same direction when the rotary motor 370 is actuated. For example, where the rotary motor 370 drives the pulley 371 in a counter-clockwise direction both belt legs 372L1, 372L2 move in extension direction 399A. Where the rotary motor 370 drives the pulley 372 in a clockwise direction both belt legs 372L1, 372L2 move in retraction direction 399B. Here, the slider 312A is coupled (in any suitable manner such as a clamp 366) to the belt leg 372L1 and slider 312B is coupled (in any suitable manner such as a clamp) to the belt leg 372L2 so that both sliders (and the stanchions 313A, 313B coupled thereto) are moved simultaneously in one of directions 399A, 399B to extend or retract the end effector 262E. The end effector drive 300E may include any suitable belt tensioner 379 to maintain any suitable predetermined belt tension of the serpentine belt 372. The end effector drive 300E operated under of any suitable controller 262C (see FIG. 2A) of the goods bot 262 to effect transfer of breakpack goods BPG in the manner described herein.

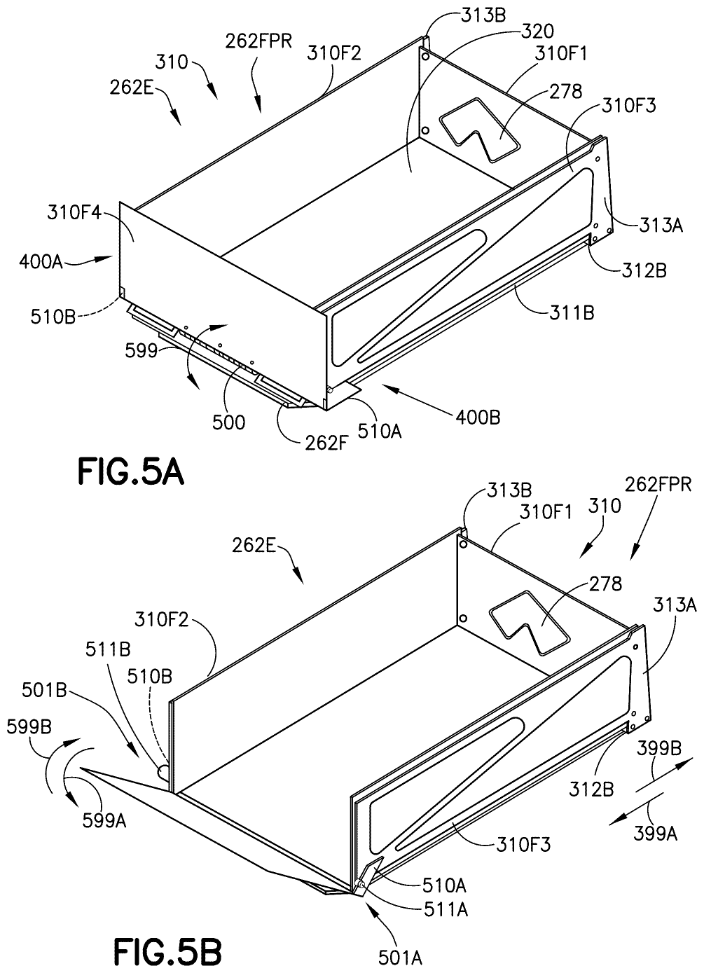

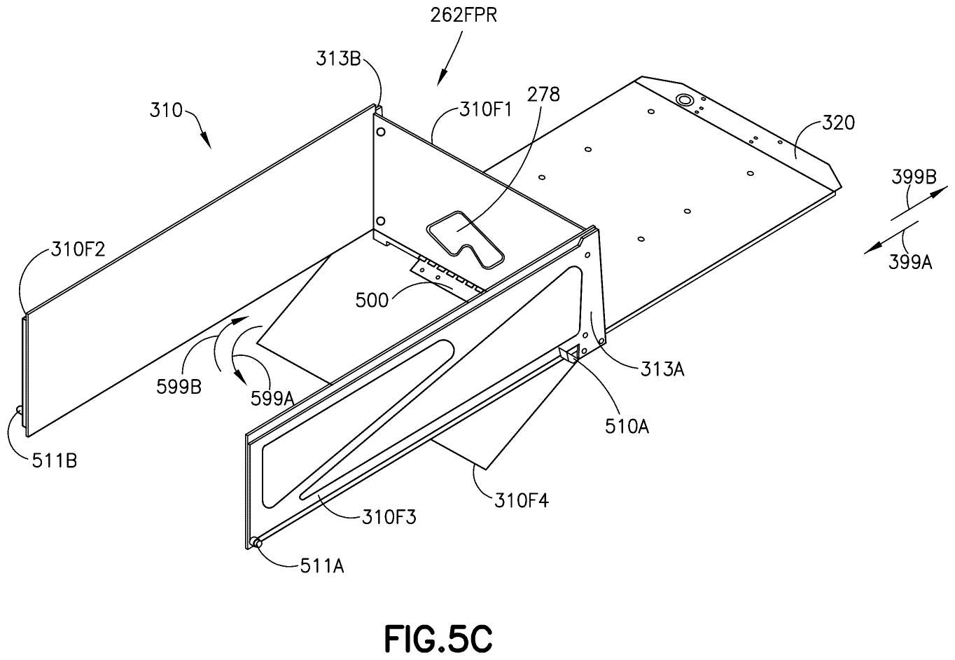

As described above, the frame member 310F4 spans between and is coupled to the side frame members 310F2, 310F3 to form the end wall 310W4. Referring to FIGS. 4A-6B the frame member 310F4 may be coupled to the side frame members 310F2, 310F3 in any suitable manner including, but not limited to: being coupled to the side frame members 310F2, 310F3 so that the frame member 310F4 has a fixed (e.g., stationary) relationship with the side frame members 310F2, 310F3 (FIGS. 4A-4B); being coupled to the side frame members 310F2, 310F3 by one or more a cammed couplings 501A, 501B where the frame member 310F4 is coupled to (with the end effector 262E retracted) and released from (with the end effector 262E extended) the side frame members 310F2, 310F3 (FIGS. 5A-5C); and being coupled to the side frame members 310F2, 310F3 by one or more hinges disposed adjacent a top 310F4T (the word “top” being used herein for convenience noting any other spatial modifier may be used) of the frame member 310F4 (FIGS. 6A-6B).

Referring to FIGS. 4A and 4B, the frame member 310F4 of the end effector 262E is coupled to the frame members 310F2, 310F3 at the ends 400A, 400B of the frame member 310F4. Here, any suitable fasteners (e.g., mechanical or chemical) are employed to rigidly fix the ends 400A, 400B of the frame member 310F4 to a respective one of the frame members 310F2, 310F3 so that the frame member 310F4 is and remains stationary relative to the frame members 310F2, 310F3 as the end effector 262E is moved in direction 399. Here, the frame member 310F4 may be employed to “bulldoze” or otherwise push breakpack goods BPG deposited in a breakpack goods container 264, with the end effector 262E extending in direction 399A and/or retracting in direction 399B, so as to move the breakpack goods BPG within the breakpack goods container 264 and substantially evenly distribute the breakpack goods within the breakpack goods container 264.

Referring to FIGS. 5A-5C, the frame member 310F4 is pivotally coupled to the one of the frame 262F and the payload support 320 in any suitable manner. In FIGS. 5A-5C the frame member 310F4 is illustrated as being pivotally coupled to the tray support 320 by a hinge 501 (e.g., piano hinge or any other suitable hinge) so as to pivot in direction 599 about a rotation axis of the hinge 501. Here, one or more ends 400A, 400B of the frame member 310F4 includes a cam 510A, 510B and a respective one or more of the frame members 310F2, 310F3 include a protrusion 511A, 511B (e.g., a roller, pin, or any other suitable protrusion that engages a respective cam 510A, 510B). Protrusion 511A and cam 510A form cammed coupling 501A and protrusion 511B and cam 510B form cammed coupling 501B.

As illustrated in FIG. 5A, with the end effector 262E in the fully retracted position, the protrusion(s) 511A, 511B engage a respective cam 510A, 510B so that the frame member 310F4 is held substantially orthogonal to the payload support 320 and the ends 400A, 400B are close coupled (e.g., in substantial contact along the entire length) with a respective one of the frame members 310F2, 310F3 (and the walls 310W2, 310W3 formed thereby). As the end effector 262E is extended in direction 399A, the protrusion (s) 511A, 511B engage the frame member 310F4 to pivot the frame member 310F4 in direction 599A. The pivoting movement of the frame member 310F4 in direction 599A (e.g., due to gravity and/or a biasing of the hinge 500 to rotate in direction 599A such as from a resilient member/torsion spring) is guided by and restrained by engagement between the protrusion(s) 511A, 511B and the respective cam 510A, 510B. Continued extension of the end effector 262E in direction 399A, to the fully extended position of the end effector 262E, effects rotation of the frame member 310F4 to a fully extended position (see FIG. 5C). In the fully extended position, the frame member 310F4 acts as a slide or chute along and on which breakpack goods BPG, being discharged from the payload bay 310 by the end effector 262E, traverse. The frame member 310F4 in the fully extended position may guide the breakpack goods BPG to predetermined areas of a breakpack goods container 264 (e.g., along or with traverse of the goods bot 262 towards and away from a breakpack goods container 264 to which the breakpack goods are deposited) to substantially evenly distributed the goods being deposited within the breakpack goods container 264. Retraction of the end effector 262E in direction 399B effects rotation of the frame member 310F4 in direction 599B and close coupling of the frame member 310F4 with the frame members 310F2, 310F3 in a manner substantially opposite to that described above.

Referring to FIGS. 6A and 6B, the frame member 310F4 is pivotally coupled to the (side) frame members 310F2, 310F3 in any suitable manner. For example, as illustrated in FIGS. 6A and 6B, one end 400A of the frame member 310F4 is pivotally coupled to frame member 310F2 at pivot coupling 601B. The other end 400B of the frame member 310F4 is pivotally coupled to the frame member 310F3 at pivot coupling 601A. In other aspects any suitable pivot coupling may be employed where the frame member 310F4 acts as a connecting cross-member between frame members 310F2, 310F3 or where the frame members 310F2, 310F3 are coupled with a connecting cross-member CCM (see FIG. 10B) of the payload bay frame that is separate and distinct from frame member 310F4 with the frame member 310F4 coupled to the connecting cross-member (such as with a hinge 500A similar to hinge 500) so that both the cross member CCM and frame member 310F4 form the end wall 310W4 of the payload bay 310. The pivot couplings 601A, 601B are disposed adjacent a top 310F4T of the frame member 310F4 so that a bottom 310F4B of the frame member 310F4 is free to pivot in direction 699 with the end effector in an extended (e.g., not fully retracted) position. Pivoting of the frame member 310F4 may be limited in direction 699A through contact between the frame member 310F4 and one or more of frame members 310F2, 310F3 (and/or the walls 310W2, 310W3 formed thereby) at respective contact surface(s) 655 (illustrated in FIG. 6A between frame members 310F4 and 310F3 noting similar contact surface(s) may be provided between frame members 310F4 and 310F2).

With the end effector 262E in a fully retracted position (as illustrated in FIG. 6A) the frame member 310F4 is held in a closed position (as illustrated in FIG. 6A where the frame 310F4 contacts one or more of the fame members 310F2, 310F3, as described herein, at contact surfaces 655) by one or more suitable releasable couplings 610. The one or more releasable couplings 610 may be any suitable magnetic coupling(s) 615, any suitable mechanical latch(es) 616, or a combination of magnetic couplings and mechanical latches. Examples of suitable mechanical latches 616 include, but are not limited to, electronically actuated bolt/pin/plunger latches, electronically actuated cam locks/latches, electronically actuated draw/toggle latches, and electronically actuated rotary latches. Examples of suitable magnetic couplings include, but are not limited to, permanent magnet couplings 615P and electromagnetic couplings 615E. For purposes of description, the one or more releasable coupling (s) 610 is/are described herein with respect to magnetic coupling (s) 615; however, it should be understood that the mechanical latches 616 may be employed in lieu of or in combination with the magnetic coupling(s) 615 where the mechanical latches are released to effect extension of the end effector 262E and are actuated/coupled upon return of the end effector 262E to the fully retracted position so as to maintain the frame member 310F4 in a closed position (as illustrated in FIG. 6A) with the goods bot 262 traversing the goods deck 130DG.

Where the magnetic coupling(s) 615 include permanent magnets, one or more permanent magnets 611A, 611B are coupled to the one or more of the frame 262F and the payload support 310. One or more corresponding permanent magnets 610A, 610B are coupled adjacent the bottom 310F4B of the frame member 310F4 so as to interact with a respective permanent magnet 611A, 611B of the frame 262F or payload support 310. The magnetic coupling formed between permanent magnets 611A, 611B and respective permanent magnets 610A, 610B may be sufficiently weak so that force/torque generated by the end effector drive 300E with extension of the end effector 262E overcomes and releases the magnetic coupling (e.g., the attraction force of the magnetic coupling is less than the extension driving force of the end effector drive 300E). With the end effector in the fully retracted position the attraction force of the magnetic coupling holds the frame member 310F4 in the closed position with goods bot 262 traverse along the goods deck 130DG. While the permanent magnets 611A, 611B, 610A, 610B are illustrated adjacent the bottom 310F4B of the frame member 310F4, in other aspects the permanent magnets 611A, 611B, 610A, 610B may be disposed anywhere between the bottom 310F4B and the top 310F4T of the frame member 310F4 (such as where the magnets 611A, 611B are mounted/coupled to stanchions that straddle the end effector 262E and are affixed to the frame 262F).

Where the magnetic coupling(s) 615 include electromagnets one or more electromagnets 613A, 613B are coupled to the one or more of the frame 262F and the payload support 310. One or more corresponding ferromagnetic elements 612A, 612B are coupled adjacent the bottom 310F4B of the frame member 310F4 so as to interact with a respective electromagnet 613A, 613B of the frame 262F or payload support 310. The magnetic coupling formed between electromagnets 613A, 613B and respective ferromagnetic element 612A, 612B may be released to effect extension of the end effector 262E and actuated with the end effector 262E in the fully retraced position to hold the frame member 310F4 in the closed position with goods bot 262 traverse along the goods deck 130DG. While the electromagnets 613A, 613B and ferromagnetic elements 612A, 612B are illustrated adjacent the bottom 310F4B of the frame member 310F4, in other aspects the electromagnets 613A, 613B and ferromagnetic elements 612A, 612B may be disposed anywhere between the bottom 310F4B and the top 310F4T of the frame member 310F4 (such as where the electromagnets 613A, 613B are mounted/coupled to stanchions that straddle the end effector 262E and are affixed to the frame 262F). The actuation and de-actuation of the electromagnets 613A, 613B may be effected with any suitable controller 262C (see FIG. 2A) of the goods bot 262 to effect transfer of breakpack goods BPG in the manner described herein.

Referring to FIGS. 2B, 3A, 4B, 8, 9A, 9B, 10, 11, and 14, the goods bot 262 effects, with the end effector 262E, controllable fill of the breakpack goods container 264 with the tote fill of breakpack goods BPG via a tote fill feedback device (such as at least one of sensors PS1-PS4, PS8, also referred to herein as a vision system) responsive to at least one of a fill level and arrangement of the tote fill. The tote fill feedback device generates a feedback signal responsive to at least one of a fill level and arrangement of the tote fill. The feedback signal is received by, e.g., controller 262C (see FIG. 2A) and as described above may effect extension and/or retraction of the end effector 262E to justify the breakpack goods BPG for offload and/or biasing within the breakpack goods container 264. As described herein, the tote fill feedback device is at least one of a camera (e.g., one or more of sensors PS2-PS4, PS8) that views the payload bay 310 and a camera (e.g., at least sensor PS1) that views the breakpack goods container 264 at the tote fill location (see interface 263 in FIG. 7A).

The goods bot 262 includes one or more sensors PS1-PS8 that effect, with the controller 262C, one or more of goods bot localization/navigation within the breakpack module 266 and object detection. The sensors PS1-PS8 are inclusive of, but are not limited to, any suitable camera (s). The object detection may be one or more of detection of objects on the goods deck 130DC (e.g., detection of other goods bots and/or debris, etc.), detection of objects at the interface 163 (e.g., goods containers, breakpack goods BPG within a goods container 264, etc.), detection of objects within the payload bay 310 of the goods bot 262 (e.g., breakpack goods within the payload bay 310, etc.), or any other suitable object on-board or off-board the goods bot 262. The at least one sensor PS1-PS8 is connected to the frame 262F and operably connected to the controller 262C, wherein the at least one sensor PS1-PS8 is arranged so as to image the payload carried in the payload bay 310, and wherein the controller 262C is configured so as to register the image of the payload, from the at least one sensor PS1-PS8, and from the image detect presence of the breakpack goods BPG, or identify the breakpack goods BPG, in the payload. The controller 262C is configured to determine, based on the detected presence or identity, conformance of the payload with a predetermined load condition based on the order, and initialized a different transport command determination of conformance (e.g., correct goods for the order, goods properly discharged from the payload bay 310, etc.) or non-conformance (e.g., incorrect goods for the order, goods not properly discharged from the payload bay 310, etc.). The controller 262C is configured to send a communication signal to an operator or management system (inclusive of controller 120), representative or corresponding to determination of conformance or non-conformance. Where non-conformance is detected the controller 262C may transport the breakpack goods BPG back to the breakpack station 140 or other area for rectification or request operator rectification where the breakpack goods BPG are not properly discharged from the payload bay 310.

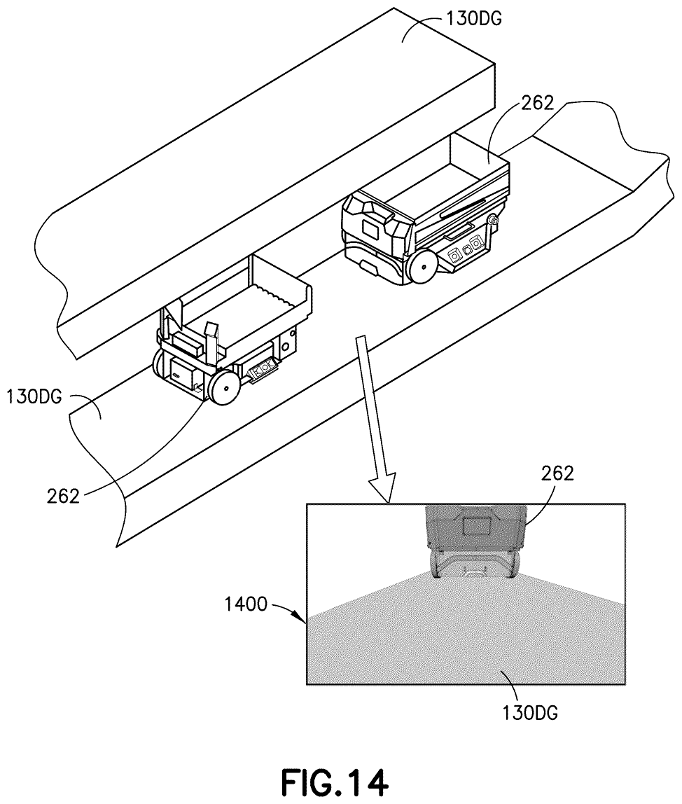

Referring to FIGS. 2B, 8, 9A, 9B, 11A and 14, the goods bot 262 includes one or more sensor PS1 disposed on or adjacent the end 262F2 (e.g., the front of the goods bot 262 relative to a direction of travel of the goods bot 262). The sensor PS1 may be a stereo vision sensor (or other suitable ranging sensor) that effects object detection and localization with respect to the goods bot 262. FIG. 14 illustrates an exemplary sensor image 1400 generated by the controller 262C (or any other suitable controller such as controller 120) from sensor data (e.g., feedback signal) obtained by sensor PS1 where the sensor data is employed (e.g., via any suitable imaging processing algorithms, including but not limited to neural networks) to effect bot traverse along the goods deck 130DG while maintaining a predetermined following distance behind another goods bot 262.

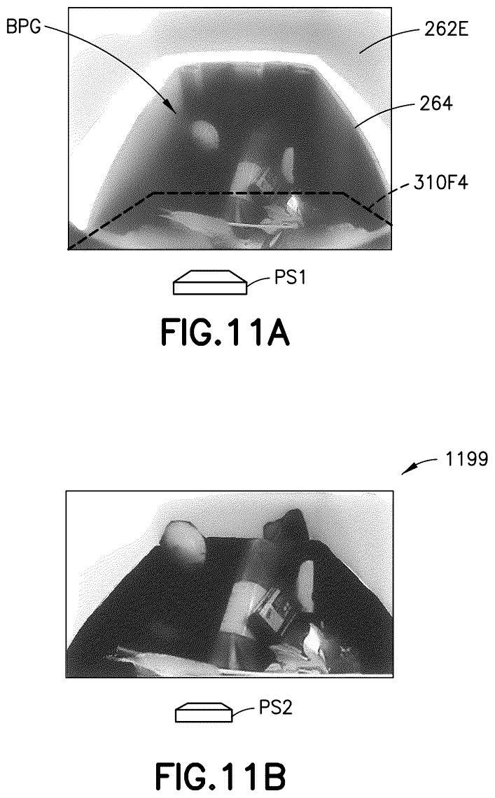

As described herein, the sensor PS1 may also effect detection of breakpack goods BPG within a breakpack goods container 264 with the goods bot 262 interfaced with the breakpack goods container 264 at the interface 263. FIG. 9B illustrates an exemplary sensor image 1400 generated by the controller 262C from sensor data (e.g., feedback signal) obtained by sensor PS1 with the goods bot 262 interfaced with the goods container 264 and with the end effector 262E in a retracted position (e.g., the controller 262C or other suitable controller, such as controller 120, includes any suitable imaging processing algorithms, including but not limited to neural networks for processing the sensor data and effecting detection of the breakpack goods BPG). FIG. 11A illustrates an exemplary sensor image 1400 generated by the controller 262C from sensor data (e.g., feedback signal) obtained by sensor PS1 with the goods bot 262 interfaced with the goods container 264 and with the end effector 262E in an extended position. The sensor data obtained by sensor PS1 with the goods bot 262 interfaced with the goods container 264 at the interface 263 is employed to effect one or more of: detection/verification of a presence of the goods container 264 (which the goods bot 262 is to interface with) at the interface 263, where presence is not detected in a predetermined interface location the goods bot 262 does not dispense breakpack goods BPG and informs controller 120 of the non-present breakpack goods container 262 (where the controller 120 may direct placement of a breakpack goods container at the predetermined interface location or prevent other bots 262 from accessing the predetermined interface location until a container 264 is delivered to that location); detection of breakpack goods BPG within the goods container 264 that may extend into the extension/retraction path of the end effector 262E where the goods bot 262 extends the end effector to “bulldoze” the goods as described herein; detection of the position(s) of breakpack goods BPG within the goods container (e.g., the goods are front-loaded in the goods container 264 towards the goods bot 262 interfaced with the goods container 264, back-loaded in the goods container 264 away from the goods bot 262 interfaced with goods container 264, or substantially evenly distributed within the goods container 264 between the front and back of the goods container 264 relative to the goods bot 262 interfaced with the goods container 264); verification that the breakpack goods BPG within the payload bay 310 are deposited to the goods container 264; verification of a breakpack goods container 264 at a predetermined interface location being at or over the predetermined fill level, where with the container 264 at or over the predetermined fill level the bot 262 will not dispense goods BPG to the container 264.

Where the goods bot 262 is configured with the frame member 310F4 hinged to the payload support 320 as illustrated in FIGS. 5A-5C (e.g. with hinge 500), the sensor data (e.g., feedback signal) from sensor S1 may be employed by the controller 262C to move the goods bot 262 in direction 399 so as to evenly distribute the breakpack goods BPG within the breakpack goods container 264 (e.g., as described herein) depending on whether the breakpack goods BPG in the breakpack goods container 264 are front-loaded or back-loaded. Where the breakpack goods BPG are font-loaded in the breakpack goods container 264 the goods bot 262 is positioned on the goods deck 130DG to discharge the breakpack goods carried thereby towards the back (e.g., the portion of the goods container 264 furthest from the goods bot 262 and goods deck 130DG) of the breakpack goods container 264. Where the breakpack goods BPG are back-loaded in the breakpack goods container 264 the goods bot 262 is positioned on the goods deck 130DG to discharge the breakpack goods carried thereby towards the front (e.g., the portion of the goods container 264 closest to the goods bot 262 and goods deck 130DC) of the breakpack goods container 264. Where the breakpack goods BPG are evenly distributed within the breakpack goods container 264, the goods bot 262 may traverse in direction 399 so that the breakpack goods BPG discharged therefrom are substantially evenly laid on top of the breakpack goods BPG already in the breakpack goods container 264. In other aspects, the goods bot 262 may discharge the breakpack goods BPG carried thereby into a breakpack goods container 264 in any suitable manner.

The above-noted sensor data (e.g., feedback signal) obtained by the sensor PS1 with respect to the breakpack goods BPG within the goods container 264 may be referred to a goods container fill feedback that is communicated from the goods bot 262 to any suitable controller, such as controller 120. The controller 120 may determine (in any suitable manner, such as with any suitable vision analysis) whether a goods container 264 is filled (e.g., over a predetermined fill level 1222 such as about 80% filled or any other suitable amount that may be greater or less than 80% filled, see FIGS. 12A-12D and 13). Where the goods container 264 is not filled the controller 120 communicates with the breakpack module 266 (at which the goods container 264 is located) to command placement of additional breakpack goods BPG (if any additional breakpack goods BPG exist for the order to which the goods container belongs) into the goods container 264. In this manner, the goods container 264 fill is maximized and the number of goods containers for any given order are minimized. The goods container fill feedback may also effect determination of end effector 262E deployment (e.g., extension) to “bulldoze” any breakpack goods BPG that extend above the top 264T (see FIGS. 12A-12B) of the breakpack goods container 264 as described herein.

Referring to FIGS. 2B, 3A, 4B, 8, 10A, 10B, and 11B, the goods bot 262 includes one or more payload bay sensors PS2, PS3, PS4, PS8 that are positioned on the goods bot 262 for imaging breakpack goods BPG held within the payload bay 310. One or more payload bay sensor(s) PS3, PS4, PS8 may be disposed above the payload bay 310 so as to “look” down into the payload by 310, and/or one or more payload bay sensor(s) PS2 may be disposed adjacent a sensor window or aperture 278 (see FIGS. 2B, 3A, and 4A-6B) in one or more of the frame members 310F1, 310F2, 310F3, 310F4 (the sensor aperture 278 is illustrated in the frame member 310F1 for exemplary purposes). The payload bay sensor PS2, PS3, PS4, PS8 may be any suitable sensors such as stereo vision sensors, any suitable ranging sensors, and monocular sensors. The controller 262C (or any other suitable controller such as controller 120) suitable includes any imaging processing algorithms (including but not limited to neural networks) for processing data obtained by the one or more payload bay sensors PS2, PS3, PS4, PS8 for breakpack goods BPG detection.

Referring to FIG. 10A, the one or more payload bay sensors include sensors PS3, PS4 that form a binocular camera pair that effects stereo vision detection of the breakpack goods BPG within the payload bay 310. Here, the sensors PS3, PS4 are located on stanchions 1010, 1011 (or any other suitable mount extending from the frame 262F or payload support 310) adjacent opposite corners of the payload bay 310 (e.g., towards end 262F1 of the goods bot 262), however, in other aspects the sensors PS3, PS4 may be positioned anywhere on the frame 262F (or payload support 320) so as to form a stereo or binocular camera pair with a field of view that covers the interior payload bay. An exemplary image 1099 obtained with sensor data (e.g., feedback signal) from the sensors PS3, PS4 is illustrated in FIG. 10A.

Referring to FIG. 10B the one or more payload bay sensors include sensor PS8 that may be a stereo vision sensor substantially similar to sensor PS1. The sensor PS8 is disposed towards the end 262F1 of the goods bot 262 substantially in line with a longitudinal (e.g., extending between ends 262F1, 262F2) centerline of the payload bay 310/goods bot 262. In other aspects the sensor PS8 may be positioned anywhere on the frame 262F (or payload support 320) so as to have a field of view that covers the interior payload bay. An exemplary image 1098 obtained with sensor data (e.g., feedback signal) from the sensor PS8 is illustrated in FIG. 10B.

Referring to FIGS. 2B, 3A, and 11B, the one or more payload bay sensors includes sensor PS2. The sensor PS2 may be any suitable sensor that effects or monocular vision binocular/stereo vision. The sensor PS2 is coupled to the payload support 320 (see, e.g., FIG. 4B) towards the end 262F1 of the goods bot 262 in any suitable manner so as to be positioned to view the interior payload bay through the sensor aperture 278. In other aspects the sensor PS2 may be positioned anywhere on the frame 262F (or payload support 320) so as to have a field of view that covers the interior payload bay. An exemplary image 1199 obtained with sensor data (e.g., feedback signal) from the sensor PS2 is illustrated in FIG. 11B.

The one or more sensors PS2, PS3, PS4, PS8 may be used individually or any suitable combination to obtain one or more of the images 1098, 1099, 1199 described above. The controller 262C (or any other suitable controller, such as controller 120) includes any suitable imaging processing algorithms, including but not limited to neural networks, that effects with the data from the sensor(s) PS2, PS3, PS4, PS8 detection of breakpack goods BPG within the payload bay 310. The controller 262C may employ the one or more sensors PS2, PS3, PS4, PS8 to verify operator (manual or automated) placement of breakpack goods BPG within the payload bay 310 at a breakpack station 140 and/or to verify discharge of the breakpack goods BPG from the payload bay 310 to a breakpack goods container 264 at the interface 263.

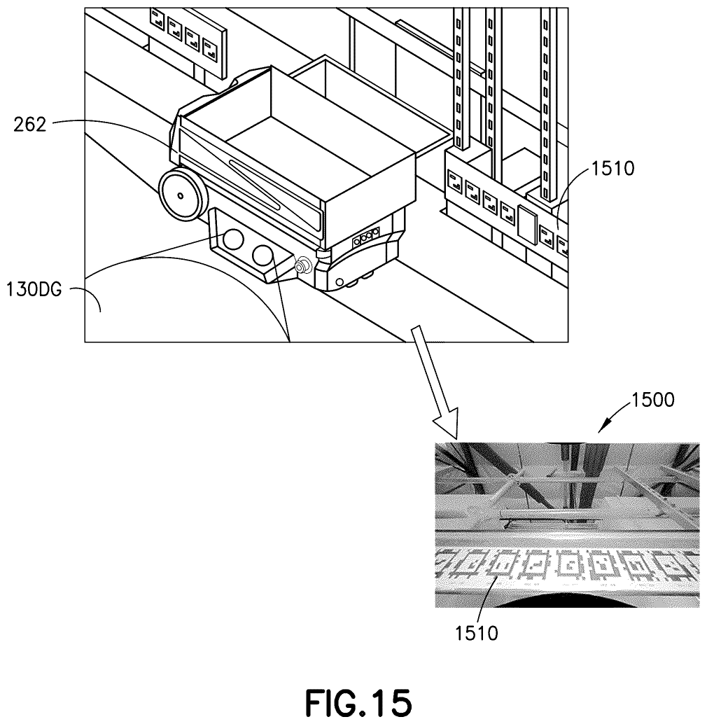

Referring to FIGS. 2A, 2B, and 15, the goods bot 262 may include lateral facing localization sensors PS5, PS6 that are configured to detect any suitable structural features of the storage and retrieval system 100 or any suitable indicia 1510 affixed thereto so as to determine, with the controller 262C (or any other suitable controller such as controller 120) a location of the goods bot along the goods deck 130DG. An exemplary image 1500 obtained with one of the sensors PS5, PS6 is illustrated in FIG. 15.

Referring to FIG. 10A, the goods bot 262 may include one or more sensor PS7 disposed on or adjacent the end 262F1 (e.g., the rear or back of the goods bot 262 relative to a direction of travel of the goods bot 262). The sensor PS7 may be a stereo vision sensor (or other suitable ranging sensor), similar to sensor PS1, that effects object detection and localization with respect to the goods bot 262 in the manner described above with respect to sensor PS1.

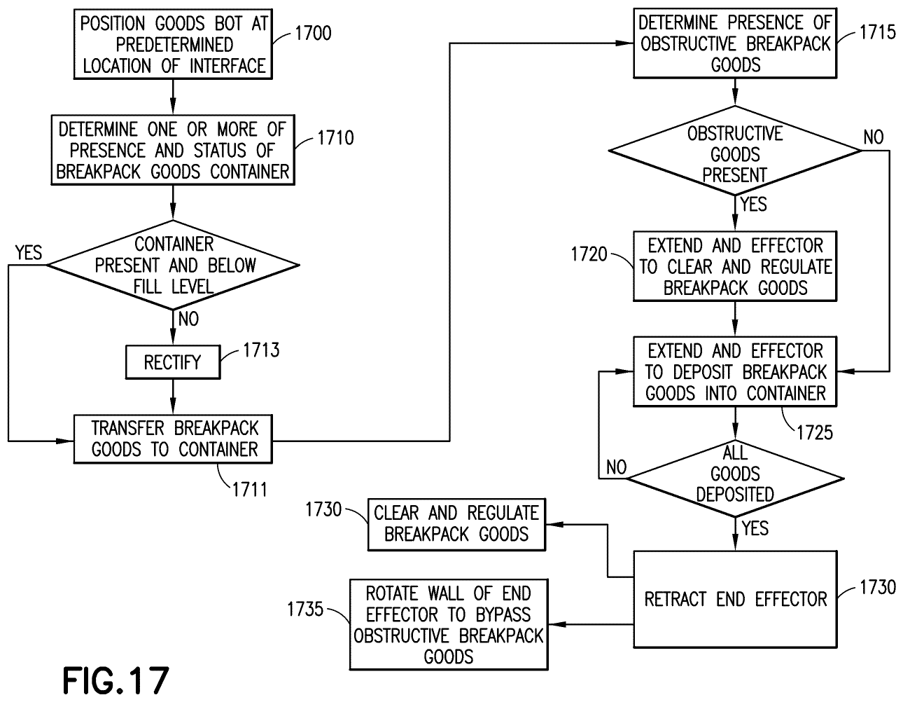

Referring to FIGS. 1, 7A, 7B, 9A, 12A and 12B an exemplary operation of the end effector 262E (as illustrated in FIGS. 4A, 4B, 6A, and 6B) will be described. The goods bot 262 traverses the goods deck 130DG to a predetermined breakpack goods container 264 assigned to a predetermined order and disposed at a predetermined location of the interface 263 (FIG. 17, Block 1700). The goods bot 262 positions itself on the goods deck 130DG at a container interface position (as illustrated in FIG. 9A) to effect breakpack goods BPG transfer from the payload bay 310 of the goods bot 262 to the breakpack goods container 264. The tote fill feedback device may be employed to determine one or more of the presence and status of a breakpack goods container 264 at the container interface position (FIG. 17, Block 1710) and determine conformance (e.g., breakpack goods container 264 is present, not filled to the predetermined fill level, etc.) of non-conformance (e.g., breakpack good container 264 is not present, is filled to or above the predetermined fill level, etc.) of the predetermined location of the interface 263. Where the presence of the breakpack goods container 264 is confirmed and the fill level of the breakpack goods container is below the predetermined fill level, the goods bot 262 effects transfer of the breakpack goods BPG held thereby to the breakpack goods container 264 (FIG. 17, Block 1711).

Where the breakpack goods container 264 is determined as being absent from the container interface position or filled above the predetermined fill level, the goods bot 262 does not effect transfer of the breakpack goods BPG held thereby to the breakpack goods container 264. The goods bot 262 may inform the controller 120 of the absence of the breakpack goods container 264 or that the predetermined breakpack goods container 264 at the predetermined location for rectification by the controller 120 (FIG. 17, Block 1713). The controller 120 may rectify the absence of the breakpack goods container by one or more of: transporting (with a container bot 110) an empty breakpack goods container 264 to the container interface position so the goods bot 262 may transfer goods thereto; assign another (empty) breakpack goods container 264 at another location of the interface 263 to the predetermined order and direct the goods bot 262 to place the breakpack goods BPG held thereon in the other breakpack goods container 264 at the other location; and prevent other goods bots 262 from delivering breakpack goods BPG to the empty container interface position. The controller 120 may rectify the filled breakpack goods container by one or more of: assigning another (empty) breakpack goods container to the predetermine order and transporting (with a container bot 110) the empty breakpack goods container 264 to another container interface position so the goods bot 262 may transfer goods thereto; assign another (empty) breakpack goods container 264 already disposed at another location of the interface 263 to the predetermined order and direct the goods bot 262 to place the breakpack goods BPG held thereon in the other breakpack goods container 264 at the other location; and prevent other goods bots 262 from delivering breakpack goods BPG to the filled breakpack goods container 264.

As illustrated in FIG. 12A, one or more breakpack goods BPG1, BPG2 may extend above a top 264T of the breakpack goods container 264 and into an extension path of the end effector 262E. The tote fill feedback device may be employed to detect these obstructive breakpack goods BPG1, BPG2 (FIG. 17, Block 1715) where the controller 262C receives feedback signals from the tote fill feedback device indicative of the presence of the obstructive breakpack goods BPG1, BPG2. Here, as described above, the end effector 262E is extended in direction 399A and, with the extension in direction 399A, the frame member 310F4 (e.g., wall 310W4) “bulldozes” or otherwise pushes/clear the breakpack goods BPG1, BPG2 within the breakpack goods container 264 from the end effector path and so as to regulate the tote fill and distribute the breakpack goods BPG1, BPG2 within the breakpack goods container 264 to effect the repeatable fill level 1222 of the breakpack goods container 264 (FIG. 17, Block 1720). The breakpack goods BPG may be pushed below the extension path of the end effector 262E. With the extension of the end effector 262E in direction 399A the frame member 310F1 (e.g., wall 310W1) pushes breakpack goods BPG3 from the payload bay 310 into the breakpack goods container 264 (see FIG. 12B). As may be realized, the distance D1 between the side frame members 310F2, 310F3 may be substantially the same as the distance D2 between side walls 264S1, 2642 of the breakpack goods container 264 (see FIG. 9B) such that the side frame members 310F2, 310F3 guide (or justify) movement of the breakpack goods BPG3 from the payload bay 310 to the breakpack goods container 264. Where the breakpack goods BPG1, BPG2 already in the breakpack goods container 264 do not obstruct end effector 262E extension, the end effector 262E is extended in a manner similar to that described above to deposit the breakpack goods BPG in the breakpack goods container 264 (FIG. 17, Block 1725). The tote fill feedback device may be employed to determine that all of the breakpack goods BPG carried by the goods bot 262 are deposited in the breakpack goods container 264, where if all goods are not deposited the end effector is again extended (or continues to extend) (FIG. 17, Block 1715). Where all goods are deposited, the end effector is retracted (FIG. 17, Block 1730).

With respect to the end effector 262E configuration of FIGS. 4A and 4B, as described herein, breakpack goods BPG within the retraction path of the end effector, with the end effector 262E moving in direction 399B, may be “bulldozed” or otherwise pushed out of the retraction path and distributed within the breakpack good container 264 in a manner similar to that described above with respect to breakpack goods BPG1, BPG2 (FIG. 17, Block 1730).

Referring also to FIGS. 12C and 12D, a further operation of the end effector 262E configuration of FIGS. 6A and 6B will be described. Here, with the breakpack goods BPG3 are deposited from the payload bay 310 into the breakpack goods container 264 as described above, and one or more breakpack goods BPG3 extend into the path of retraction of the end effector 262E. With end effector 262E movement (retraction) in direction 399B and upon interaction of the frame member 310F4 (e.g., wall 310W4) with the breakpack goods BPG3, the frame member 310F4 passively pivots about the pivot couplings 601A, 601B in direction 699B and rides on the breakpack goods BPG3 so that the end effector 262E is retracted past (so as to bypass) the breakpack goods BPG3 without the breakpack goods BPG3 obstructing the retract movement of the end effector 262E (FIG. 17, Block 1735). In other aspects, the frame member 310F4 (e.g., wall 310W4) may be actively driven in direction 699B by any suitable actuators to lift the frame member 310F4 above the breakpack goods BPG within the breakpack goods container 264. With the end effector 262E in the fully retracted position the goods bot 262 may traverse the goods deck 130DG to the breakpack station 140 for transport of different breakpack goods BPG. Alternatively, sensors (such as those described herein) on the goods bot 262 may be employed to detect the breakpack goods BPG3 extending above the top 264T of the breakpack goods container 264 and based on the sensor information extend the end effector 262E in direction 399A to distribute the breakpack goods BPG3 within the breakpack goods container 264 (see FIG. 12D).

Referring to FIGS. 1, 5A-5C, 9A, and 13 an exemplary operation of the end effector 262E (as illustrated in FIGS. 5A-5C) will be described. The goods bot 262 traverses the goods deck 130DG to a predetermined breakpack goods container 264 disposed at a predetermined location of the interface 263. The goods bot 262 positions itself on the goods deck 130DG at a container interface position (as illustrated in FIG. 9A) to effect breakpack goods BPG transfer from the payload bay 310 of the goods bot 262 to the breakpack goods container 264. With the goods bot 262 positioned adjacent the breakpack goods container 264, the end effector 262E is extended in direction 399A. With the extension of the end effector 262E, the protrusions 511A, 511B engages the frame member 310F4 and cam 510A, 510B to rotate the frame member 310F4 (e.g., wall 310W4) in direction 599A to the fully extended position in the manner described above. Here, the rotation of the frame member 310F4 in direction 599A may push any breakpack goods BPG within the breakpack goods container 264 down into the breakpack goods container 264 to effect the repeatable fill level 1222 of the breakpack goods container 264. Also, with extension of the end effector in direction 399A, the frame member 310F1 pushes breakpack goods BPG from the payload bay 310 into the breakpack goods container 264. As described above, the distance D1 between the side frame members 310F2, 310F3 may be substantially the same as the distance D2 between side walls 264S1, 264S2 of the breakpack goods container 264 (See FIG. 9B) such that the side frame members 310F2, 310F3 guide movement of the breakpack goods BPG from the payload bay 310 to the breakpack goods container 264.

As described above, with the frame member 310F4 in the fully extended position, the breakpack goods BPG are pushed from the payload bay 310 by frame member 310F1, and slide along the frame member 310F4. The frame member 310F4 directs the breakpack goods BPG towards a center of the breakpack goods container 264; however, with traverse of the goods bot 262 in direction 399A the breakpack goods sliding along the frame member 310F4 may be directed past the center of the breakpack goods container 264 (e.g., towards a far side of the container 264 relative to the goods bot 262), and with traverse of the goods bot 262 in direction 399B the breakpack goods sliding along the frame member 310F4 may be directed forward of the center of the breakpack goods container 264 (e.g., towards a near side of container 264 relative to the goods bot 262). Here, moving the goods bot 262 towards and away from the breakpack goods container 264 substantially evenly distributes the breakpack goods BPG within the breakpack goods container 264.

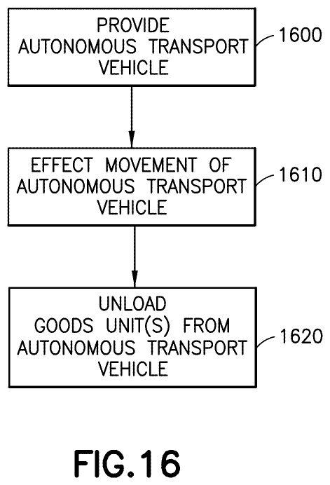

Referring to FIGS. 1, 2A, 2B, 7A, 7B, 9A, 9B, 12A-12D, 13, and 16, an exemplary method for transferring a goods unit for filling a shipping tote or container will be described. The method includes providing the goods bot (e.g., autonomous transport vehicle) 262 (FIG. 16, Block 1600) where, as described herein, the goods bot 262 has a frame 262F and a payload bay 310 connected to the frame 262, the frame 262F being configured so that the goods bot 262 traverses, as a unit, on at least one of a transfer deck (e.g., goods deck 130DG) and a ramp 130DGR, and the payload bay 310 holds the breakpack goods loaded on the goods bot 262.

Movement of the goods bot 262 is effected (FIG. 16, Block 1610), with the controller 262C connected to the frame 262F, on the at least one of the goods deck 130DG and the ramp 130DGR so that the goods bot 262 roams freely via autonomous navigation, from a first location (such as a breakpack station 140) to a different second location (such as at interface 263—see FIGS. 7A, 9A and 9B), wherein the first location is a supply of the breakpack goods BPG, and the second location is a tote fill location based on an order. The breakpack good(s) (e.g., goods unit (s)) BPG are unloaded from the payload bay 310 of the goods bot 262 (FIG. 16, Block 1620) with the end effector 262E of the payload bay 310, where the end effector 262E is arranged to extend and unload the breakpack goods BPG from the payload bay 310, and where the end effector 262E forms a fill placement regulator 262FPR that regulates placement of the breakpack goods BPG unloaded in filling the breakpack goods container 264 so that each breakpack goods container 264 at each tote fill location (e.g., at interface 263) is repeatably filled, with a tote fill, substantially to a predetermined fill level 1222 (see FIGS. 12A-12D and 13).

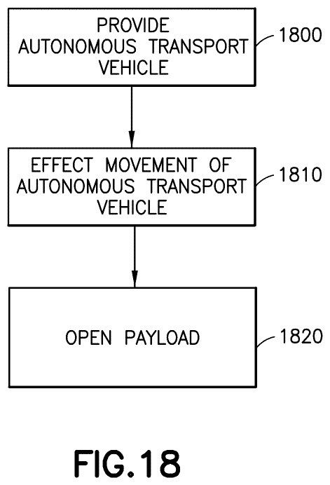

Referring to FIGS. 1, 2A, 2B, 7A, 7B, 9A, 9B, 12A-12D, 13, and 18, a method for transferring a breakpack goods BPG for filling a shipping tote or container 264 is provided. The method includes providing a goods bot (autonomous transport vehicle) 262 (FIG. 18, Block 1800) having the frame 262F and a payload bay 310 forming a tray connected to the frame 262F. The frame 262F is configured so that the goods bot 262 traverses, as a unit, on at least one of a goods deck 130DG and a ramp 130DGR, and the payload bay 310 holds the breakpack goods BPG loaded on the goods bot 262. Movement of the goods bot 262 is effected (FIG. 18, Block 1810), with the controller 262C connected to the frame 262F, on the at least one of the goods deck 130DG and the ramp 130DGR so that the autonomous transport vehicle 262 roams freely via autonomous navigation, from a first location (such as the breakpack station 140) to a different second location (such as a location of a breakpack goods container 264 at the interface 263), wherein the first location is a supply of the goods unit, and the second location is a tote fill location based on an order. An end effector 262E formed by the tray, opens the payload bay 310 (FIG. 18, Block 1820), engaging and controllably moving the payload bay 310, where the tray has sides 310W1-310W4 that are movably connected to the payload bay 310 so as to extend outward, away from the frame 262F, from a closed position, closing the payload bay 310, and an extended position, opening the payload bay 310, where the sides 310W1-310W4 of the tray form the end effector 262E.

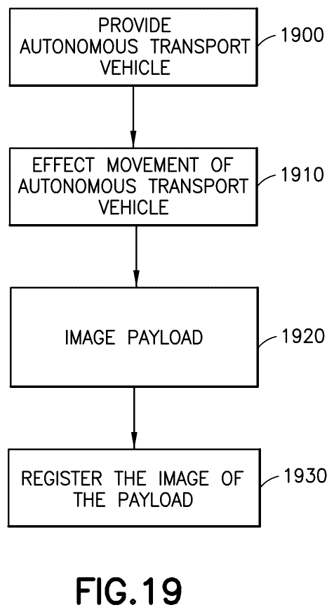

Referring to FIGS. 1, 2A, 2B, 7A, 7B, 9A, 9B, 12A-12D, 13, and 19, a method for transferring a breakpack goods BPG for filling a shipping tote or container 264 is provided. The method includes providing goods bot (autonomous transport vehicle) 262 (FIG. 19, Block 1900) having a frame 262F and a payload bay 310 connected to the frame 262F for holding the breakpack goods BPG loaded on the goods bot 262, the frame 262F being configured so that the goods bot 262 traverses, as a unit, on at least one of a goods deck (transfer deck) 130DG and a ramp 130DGR, and the payload bay 310 holds the breakpack goods BPG loaded on the goods bot 262. Movement of the goods bot 262 is effected (FIG. 19, Block 1910), with a controller 262C connected to the frame 262F, on the at least one of the goods deck 130DG and the ramp 130DGR so that the goods bot 262 roams freely via autonomous navigation, from a first location (such as breakpack station 140) to a different second location (such as a location of a breakpack goods container 264 at the interface 263), wherein the first location is a supply of the breakpack goods BPG, and the second location is a tote fill location based on an order. The payload bay 310 is imaged (FIG. 19, Block 1920) with a vision system (at least one of sensors PS1-PS8) having at least one camera (at least one of sensors PS1-PS8) connected to the frame 262F and operably connected to the controller 262C. The controller 262C registers the image of the payload bay 310 (FIG. 19, Block 1930), from the at least one camera, and from the image detects a presence of the breakpack goods BPG, or identifies the breakpack goods BPG, in the payload bay 310.

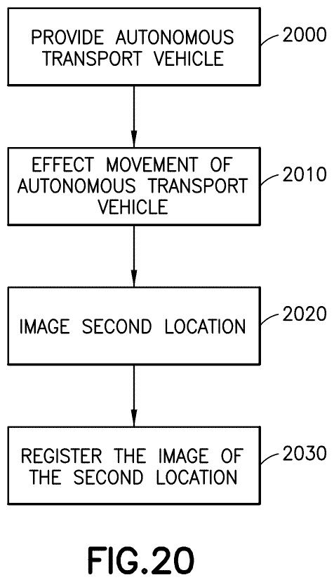

Referring to FIGS. 1, 2A, 2B, 7A, 7B, 9A, 9B, 12A-12D, 13, and 20, a method for transferring a breakpack goods BPG for filling a shipping tote or container 264 is provided. The method includes providing a goods bot (autonomous transport vehicle) 262 (FIG. 20, Block 2000) having a frame 262F and a payload bay 310 connected to the frame 262F for holding the breakpack goods BPG loaded on the goods bot 262, the frame 262F being configured so that the goods bot 262 traverses, as a unit, on at least one of a goods deck (transfer deck) 130DG and a ramp 130DGR, and the payload bay 310 holds the breakpack goods BPG loaded on the goods bot 262. Movement of the goods bot is effected (FIG. 20, Block 2010), with a controller 262C connected to the frame 262F, on the at least one of the goods deck 130DG and the ramp 130DGR so that the goods bot 262 roams freely via autonomous navigation, from a first location (such as breakpack station 140) to a different second location (such as a location of a breakpack goods container 264 at the interface 263), wherein the first location is a supply of the breakpack goods BPG, and the second location is a tote fill location based on an order. The second location is imaged (FIG. 20, Block 2020) with at least one camera (at least one of sensors PS1-PS8) of a vision system, where the at least one camera (at least one of sensors PS1-PS8) is connected to the frame and operably connected to the controller 262C. The image from the at least one camera (at least one of sensors PS1-PS8) is registered with the controller 262C (FIG. 20, Block 2030) and the controller 262C detects from the image a presence of the tote 264 at the second location.

In accordance with one or more aspects of the disclosed embodiment, an autonomous transport vehicle, for transferring a goods unit for filling a shipping tote or container, is provided. The autonomous transport vehicle includes: a frame configured so that the autonomous transport vehicle traverses, as a unit, on at least one of a transfer deck and a ramp; a controller connected to the frame and configured to effect movement of the autonomous transport vehicle on the at least one of the transfer deck and the ramp so that the vehicle roams freely via autonomous navigation, from a first location to a different second location, wherein the first location is a supply of the goods unit, and the second location is a tote fill location based on an order; and a payload connected to the frame for holding the goods unit loaded on the autonomous transport vehicle, the payload having an end effector arranged to extend and unload the goods unit from the payload, the end effector forms a fill placement regulator that regulates placement of the goods unit unloaded in filling the tote so that each tote at each tote fill location is repeatably filled, with a tote fill, substantially to a predetermined fill level.

In accordance with one or more aspects of the disclosed embodiment, the fill placement regulator regulates each tote fill substantially agnostic with respect to size, shape and quantity of each goods unit in the tote fill of a common tote.

In accordance with one or more aspects of the disclosed embodiment, the end effector has at least one side wall containing the payload; the end effector extends from a closed location to an open extended position; and the end effector has a justification feature that contacts the goods unit so as to offload the goods unit that unloads the goods unit from the payload.

In accordance with one or more aspects of the disclosed embodiment, the end effector has a justification feature that is disposed so as to the tote fill, and bias goods units of the tote fill during extension or retraction of the end effector, so as to regulate the tote fill of each tote substantially to the repeatable fill level.

In accordance with one or more aspects of the disclosed embodiment, the autonomous transport vehicle effects, with the end effector, controllable fill of the tote with the tote fill of goods units via a tote fill feedback device responsive to at least one of a fill level and arrangement of the tote fill.

In accordance with one or more aspects of the disclosed embodiment, the autonomous transport vehicle further incudes a tote fill feedback device that generates a feedback signal responsive to at least one of a fill level and arrangement of the tote fill.

In accordance with one or more aspects of the disclosed embodiment, the tote fill feedback device is at least one of a camera that views the payload and camera that views the tote at the tote fill location.

In accordance with one or more aspects of the disclosed embodiment, the fill placement regulator, of the end effector, effects repeatably retraction of the end effector to the closed position at each placement of the goods unit independent of obstruction from the tote fill at each placement.

In accordance with one or more aspects of the disclosed embodiment, the end effector has a movable wall, that moves with retraction of the end effector so as to clear each tote fill obstruction.

In accordance with one or more aspects of the disclosed embodiment, a method for transferring a goods unit, for filling a shipping tote or container, is provided. The method includes: providing an autonomous transport vehicle having a frame and a payload connected to the frame, the frame being configured so that the autonomous transport vehicle traverses, as a unit, on at least one of a transfer deck and a ramp, and the payload holds the goods unit loaded on the autonomous transport vehicle; effecting movement of the autonomous transport vehicle, with a controller connected to the frame, on the at least one of the transfer deck and the ramp so that the autonomous transport vehicle roams freely via autonomous navigation, from a first location to a different second location, wherein the first location is a supply of the goods unit, and the second location is a tote fill location based on an order; and unloading the goods unit from the payload with an end effector of the payload, the end effector being arranged to extend and unload the goods unit from the payload, where the end effector forms a fill placement regulator that regulates placement of the goods unit unloaded in filling the tote so that each tote at each tote fill location is repeatably filled, with a tote fill, substantially to a predetermined fill level.

In accordance with one or more aspects of the disclosed embodiment, the method further includes regulating, with the fill placement regulator, each tote fill substantially agnostic with respect to size, shape and quantity of each goods unit in the tote fill of a common tote.

In accordance with one or more aspects of the disclosed embodiment, the end effector has at least one side wall containing the payload, and the method further includes: extending the end effector from a closed location to an open extended position; and unloading the goods unit from the payload with a justification feature of the end effector that contacts the goods unit so as to offload the goods unit from the payload.

In accordance with one or more aspects of the disclosed embodiment, the method further biasing, a includes with justification feature of the end effector that is disposed so as to the tote fill, goods units of the tote fill during extension or retraction of the end effector, so as to regulate the tote fill of each tote substantially to the repeatable fill level.

In accordance with one or more aspects of the disclosed embodiment, the method further includes effecting, with the end effector of the autonomous transport vehicle, controllable fill of the tote with the tote fill of goods units via a tote fill feedback device responsive to at least one of a fill level and arrangement of the tote fill.

In accordance with one or more aspects of the disclosed embodiment, the method further includes generating, with a tote fill feedback device, a feedback signal responsive to at least one of a fill level and arrangement of the tote fill.

In accordance with one or more aspects of the disclosed embodiment, the tote fill feedback device is at least one of a camera that views the payload and camera that views the tote at the tote fill location.

In accordance with one or more aspects of the disclosed embodiment, the method further includes effecting, with the fill placement regulator of the end effector, repeatable retraction of the end effector to the closed position at each placement of the goods unit independent of obstruction from the tote fill at each placement.

In accordance with one or more aspects of the disclosed embodiment, the end effector has a movable wall, that moves with retraction of the end effector so as to clear each tote fill obstruction.

In accordance with one or more aspects of the disclosed embodiment, an autonomous transport vehicle, for transferring a goods unit for filling a shipping tote or container, is provided. The autonomous transport vehicle includes: a frame configured so that the autonomous transport vehicle traverses, as a unit, on at least one of a transfer deck and a ramp; a controller connected to the frame and configured to effect movement of the autonomous transport vehicle on the at least one of the transfer deck and the ramp so that the vehicle roams freely via autonomous navigation, from a first location to a different second location, wherein the first location is a supply of the goods unit, and the second location is a tote fill location based on an order; and one or more handles coupled to the frame, the one or more handles being shaped and sized for human porting of the autonomous transport vehicle.

In accordance with one or more aspects of the disclosed embodiment, the one or more handles are coupled to the frame by a retractable coupling.

In accordance with one or more aspects of the disclosed embodiment, the retractable coupling is one or more of a hinged coupling and a sliding coupling.

In accordance with one or more aspects of the disclosed embodiment, the autonomous transport vehicle further includes a payload connected to the frame for holding the goods unit loaded on the autonomous transport vehicle, the payload having a fill placement regulator that regulates placement of the goods unit unloaded in filling the tote so that each tote at each tote fill location is repeatably filled, with a tote fill, substantially to a predetermined fill level

In accordance with one or more aspects of the disclosed embodiment, the fill placement regulator regulates each tote fill substantially agnostic with respect to size, shape and quantity of each goods unit in the tote fill of a common tote.

In accordance with one or more aspects of the disclosed embodiment, the fill placement regulator has at least one side wall containing the payload; the fill placement regulator extends from a closed location to an open extended position; and the fill placement regulator has a justification feature that contacts the goods unit so as to offload the goods unit that unloads the goods unit from the payload.

In accordance with one or more aspects of the disclosed embodiment, the fill placement regulator has a justification feature that is disposed so as to the tote fill, and bias goods units of the tote fill during extension or retraction of the fill placement regulator, so as to regulate the tote fill of each tote substantially to the repeatable fill level.

In accordance with one or more aspects of the disclosed embodiment, the autonomous transport vehicle effects, with the fill placement regulator, controllable fill of the tote with the tote fill of goods units via a tote fill feedback device responsive to at least one of a fill level and arrangement of the tote fill.

In accordance with one or more aspects of the disclosed embodiment, the autonomous transport vehicle further includes a tote fill feedback device that generates a feedback signal responsive to at least one of a fill level and arrangement of the tote fill.

In accordance with one or more aspects of the disclosed embodiment, the tote fill feedback device is at least one of a camera that views the payload and camera that views the tote at the tote fill location.

In accordance with one or more aspects of the disclosed embodiment, the fill placement regulator effects repeatably retraction of the end effector to the closed position at each placement of the goods unit independent of obstruction from the tote fill at each placement.

In accordance with one or more aspects of the disclosed embodiment, the fill placement regulator has a movable wall, that moves with retraction of the fill placement regulator so as to clear each tote fill obstruction.

In accordance with one or more aspects of the disclosed embodiment, a method for transferring a goods unit, for filling a shipping tote or container, is provided. The method includes: providing an autonomous transport vehicle having a frame and a payload connected to the frame, the frame being configured so that the autonomous transport vehicle traverses, as a unit, on at least one of a transfer deck and a ramp, and the payload holds the goods unit loaded on the autonomous transport vehicle; effecting movement of the autonomous transport vehicle, with a controller connected to the frame, on the at least one of the transfer deck and the ramp so that the autonomous transport vehicle roams freely via autonomous navigation, from a first location to a different second location, wherein the first location is a supply of the goods unit, and the second location is a tote fill location based on an order; and porting of the autonomous transport vehicle with one or more handles coupled to the frame, the one or more handles being shaped and sized for human porting of the autonomous transport vehicle.

In accordance with one or more aspects of the disclosed embodiment, the one or more handles are coupled to the frame by a retractable coupling.

In accordance with one or more aspects of the disclosed embodiment, the retractable coupling is one or more of a hinged coupling and a sliding coupling.

In accordance with one or more aspects of the disclosed embodiment, the method further includes regulating, with a fill placement regulator, placement of the goods unit unloaded in filling the tote so that each tote at each tote fill location is repeatably filled, with a tote fill, substantially to a predetermined fill level, where a payload having the fill placement regulator is connected to the frame for holding the goods unit loaded on the autonomous transport vehicle.

In accordance with one or more aspects of the disclosed embodiment, the fill placement regulator regulates each tote fill substantially agnostic with respect to size, shape and quantity of each goods unit in the tote fill of a common tote.

In accordance with one or more aspects of the disclosed embodiment, the fill placement regulator has at least one side wall containing the payload, the method further includes: extending the fill placement regulator from a closed location to an open extended position; and unloading the goods unit from the payload with a justification feature of the fill placement regulator that contacts the goods unit so as to offload the goods unit from the payload.

In accordance with one or more aspects of the disclosed embodiment, the method further includes effecting, with a justification feature of the fill placement regulator that is disposed so as to the tote fill, goods units of the tote fill during extension or retraction of the fill placement regulator, so as to regulate the tote fill of each tote substantially to the repeatable fill level.

In accordance with one or more aspects of the disclosed embodiment, the method further includes effecting, with the fill placement regulator of the autonomous transport vehicle, controllable fill of the tote with the tote fill of goods units via a tote fill feedback device responsive to at least one of a fill level and arrangement of the tote fill.

In accordance with one or more aspects of the disclosed embodiment, the method further includes generating, with a tote fill feedback device, a feedback signal responsive to at least one of a fill level and arrangement of the tote fill.

In accordance with one or more aspects of the disclosed embodiment, the tote fill feedback device is at least one of a camera that views the payload and camera that views the tote at the tote fill location.

In accordance with one or more aspects of the disclosed embodiment, the method further includes effecting, with the fill placement regulator, repeatable retraction of the end effector to the closed position at each placement of the goods unit independent of obstruction from the tote fill at each placement.

In accordance with one or more aspects of the disclosed embodiment, the fill placement regulator has a movable wall, that moves with retraction of the fill placement regulator so as to clear each tote fill obstruction.

In accordance with one or more aspects of the disclosed embodiment, an autonomous transport vehicle for transferring a goods unit, for filling a shipping tote or container, is provided. The vehicle including: a frame configured so that the autonomous transport vehicle traverses, as a unit, on at least one of a transfer deck and a ramp; a controller connected to the frame and configured to effect movement of the vehicle on the at least one of the transfer deck and the ramp so that the vehicle roams freely via autonomous navigation, from a first location to a different second location, wherein the first location is a supply of the goods unit, and the second location is a tote fill location based on an order; and a payload connected to the frame for holding the goods unit loaded on the vehicle, the payload forms a tray having sides that are movably connected to the payload so as to extend outward, away from the frame, from a closed position, closing the payload, and an extended position, opening the payload, the sides of the tray forming an end effector that, opens the payload, engages and controllably moves the payload, with extension of the tray that unloads the goods unit from the payload.

In accordance with one or more aspects of the disclosed embodiment, the sides of the tray is are configured to slide, with at least one degree of freedom, that extends and retracts the sides of the tray so as to open and close the payload.

In accordance with one or more aspects of the disclosed embodiment, the sides of the tray have a justification edge that biases the tote fill so as to conform the tote fill to a substantially predetermined level.

In accordance with one or more aspects of the disclosed embodiment, a method, for transferring a goods unit for filling a shipping tote or container, is provided. The method includes: providing an autonomous transport vehicle having a frame and a payload forming a tray connected to the frame, the frame being configured so that the autonomous transport vehicle traverses, as a unit, on at least one of a transfer deck and a ramp, and the payload holds the goods unit loaded on the autonomous transport vehicle; effecting movement of the autonomous transport vehicle, with a controller connected to the frame, on the at least one of the transfer deck and the ramp so that the autonomous transport vehicle roams freely via autonomous navigation, from a first location to a different second location, wherein the first location is a supply of the goods unit, and the second location is a tote fill location based on an order; and opening, with an end effector formed by the tray, the payload, engaging and controllably moving the payload, where the tray has sides that are movably connected to the payload so as to extend outward, away from the frame, from a closed position, closing the payload, and an extended position, opening the payload, where the sides of the tray form the end effector.

In accordance with one or more aspects of the disclosed embodiment, the sides of the tray slide, with at least one degree of freedom, that extends and retracts the sides of the tray so as to open and close the payload.

In accordance with one or more aspects of the disclosed embodiment, the method further includes, biasing, with a justification edge of the sides of the tray, the tote fill so as to conform the tote fill to a substantially predetermined level.

In accordance with one or more aspects of the disclosed embodiment, an autonomous transport vehicle for transferring a goods unit, for filling a shipping tote or container, is provided. The autonomous transport vehicle includes: a frame configured so that the autonomous transport vehicle traverses, as a unit, on at least one of a transfer deck and a ramp; a controller connected to the frame and configured to effect movement of the autonomous transport vehicle on the at least one of the transfer deck and the ramp so that the autonomous transport vehicle roams freely via autonomous navigation, from a first location to a different second location, wherein the first location is a supply of the goods unit, and the second location is a tote fill location of based on an order; a payload connected to the frame for holding the goods unit loaded on the autonomous transport vehicle; and a vision system with at least one camera connected to the frame and operably connected to the controller, wherein the at least one camera is arranged so as to image the payload, and wherein the controller is configured so as to register the image of the payload, from the at least one camera, and from the image detect presence of the goods unit, or identify the goods unit, in the payload.

In accordance with one or more aspects of the disclosed embodiment, the controller is configured to determine, based on the detected presence or identity, conformance of the payload with a predetermined load condition based on the order, and initialized a different transport command based on determination of conformance or non-conformance.

In accordance with one or more aspects of the disclosed embodiment, the controller is configured to send a communication signal to an operator or management system, representative or corresponding to determination of conformance or non-conformance.

In accordance with one or more aspects of the disclosed embodiment, a method for transferring a goods unit for filling a shipping tote or container is provided. The method includes: providing an autonomous transport vehicle having a frame and a payload connected to the frame for holding the goods unit loaded on the autonomous transport vehicle, the frame being configured so that the autonomous transport vehicle traverses, as a unit, on at least one of a transfer deck and a ramp, and the payload holds the goods unit loaded on the autonomous transport vehicle; effecting movement of the autonomous transport vehicle, with a controller connected to the frame, on the at least one of the transfer deck and the ramp so that the autonomous transport vehicle roams freely via autonomous navigation, from a first location to a different second location, wherein the first location is a supply of the goods unit, and the second location is a tote fill location based on an order; imaging the payload with a vision system having at least one camera connected to the frame and operably connected to the controller; and registering, with the controller, the image of the payload, from the at least one camera, and from the image detect presence of the goods unit, or identify the goods unit, in the payload.

In accordance with one or more aspects of the disclosed embodiment, the method further includes determining, with the controller, based on the detected presence or identity, conformance of the payload with a predetermined load condition based on the order, and initialized a different transport command based on determination of conformance or non-conformance.

In accordance with one or more aspects of the disclosed embodiment, the method further includes sending, with the controller, a communication signal to an operator or management system, representative or corresponding to determination of conformance or non-conformance.

In accordance with one or more aspects of the disclosed embodiment, an autonomous transport vehicle for transferring a goods unit, for filling a shipping tote or container, is provided. The autonomous transport vehicle includes: a frame configured so that the autonomous transport vehicle traverses, as a unit, on at least one of a transfer deck and a ramp; a controller connected to the frame and configured to effect movement of the autonomous transport vehicle on the at least one of the transfer deck and the ramp so that the autonomous transport vehicle roams freely via autonomous navigation, from a first location to a different second location, wherein the first location is a supply of the goods unit, and the second location is a tote fill location of based on an order; a payload connected to the frame for holding the goods unit loaded on the autonomous transport vehicle; and a vision system with at least one camera connected to the frame and operably connected to the controller, wherein the at least one camera is arranged so as to image the second location and wherein the controller is configured so as to register the image, from the at least one camera, and from the image detect presence of the tote at the second location.

In accordance with one or more aspects of the disclosed embodiment, the controller is configured to determine, based on the detected presence, conformance with a predetermined unload condition of the goods unit at the second location, and select between effecting unloading and holding of the goods unit in the payload based on determination of conformance or non-conformance.

In accordance with one or more aspects of the disclosed embodiment, the controller is configured to send a communication signal to an operator or management system, representative or corresponding to determination of conformance or non-conformance.

In accordance with one or more aspects of the disclosed embodiment, a method for transferring a goods unit for filling a shipping tote or container is provided. The method includes: providing an autonomous transport vehicle having a frame and a payload connected to the frame for holding the goods unit loaded on the autonomous transport vehicle, the frame being configured so that the autonomous transport vehicle traverses, as a unit, on at least one of a transfer deck and a ramp, and the payload holds the goods unit loaded on the autonomous transport vehicle; effecting movement of the autonomous transport vehicle, with a controller connected to the frame, on the at least one of the transfer deck and the ramp so that the autonomous transport vehicle roams freely via autonomous navigation, from a first location to a different second location, wherein the first location is a supply of the goods unit, and the second location is a tote fill location based on an order; imaging the second location with at least one camera of a vision system, where the at least one camera is connected to the frame and operably connected to the controller; and registering the image from the at least one camera with the controller and detecting from the image a presence of the tote at the second location.

In accordance with one or more aspects of the disclosed embodiment, the method further including determining, with the controller, based on the detected presence, conformance with a predetermined unload condition of the goods unit at the second location, and select between effecting unloading and holding of the goods unit in the payload based on determination of conformance or non-conformance.

In accordance with one or more aspects of the disclosed embodiment, method further including sending, with the controller, a communication signal to an operator or management system, representative or corresponding to determination of conformance or non-conformance.

It should be understood that the foregoing description is only illustrative of the aspects of the disclosed embodiment. Various alternatives and modifications can be devised by those skilled in the art without departing from the aspects of the disclosed embodiment. Accordingly, the aspects of the disclosed embodiment are intended to embrace all such alternatives, modifications and variances that fall within the scope of any claims appended hereto. Further, the mere fact that different features are in mutually recited different dependent or independent claims does not indicate that a combination of these features cannot be advantageously used, such a combination remaining within the scope of the aspects of the disclosed embodiment.

What is claimed is:

1. An autonomous transport vehicle for transferring a goods unit for filling a shipping tote or container, the autonomous transport vehicle comprising:
a frame configured so that the autonomous transport vehicle traverses, as a unit, on at least one of a transfer deck and a ramp;
a controller connected to the frame and configured to effect movement of the autonomous transport vehicle on the at least one of the transfer deck and the ramp so that the autonomous transport vehicle roams freely via autonomous navigation, from a first location to a different second location, wherein the first location is a supply of the goods unit, and the second location is a tote fill location based on an order; and
a payload connected to the frame for holding the goods unit loaded on the autonomous transport vehicle, the payload having an end effector arranged to extend and unload the goods unit from the payload, the end effector forms a fill placement regulator that regulates placement of the goods unit unloaded in filling the tote so that each tote at each tote fill location is repeatably filled, with a tote fill, substantially to a predetermined fill level.

2. The autonomous transport vehicle of claim 1, wherein the fill placement regulator regulates each tote fill substantially agnostic with respect to size, shape and quantity of each goods unit in the tote fill of a common tote.

3. The autonomous transport vehicle of claim 1, wherein:
the end effector has at least one side wall containing the payload;
the end effector extends from a closed location to an open extended position; and
the end effector has a justification feature that contacts the goods unit so as to offload the goods unit that unloads the goods unit from the payload.

4. The autonomous transport vehicle of claim 1, wherein the end effector has a justification feature that is disposed so as to the tote fill, and bias goods units of the tote fill during extension or retraction of the end effector, so as to regulate the tote fill of each tote substantially to the repeatable fill level.

5. The autonomous transport vehicle of claim 1, wherein the autonomous transport vehicle effects, with the end effector, controllable fill of the tote with the tote fill of goods units via a tote fill feedback device responsive to at least one of a fill level and arrangement of the tote fill.

6. The autonomous transport vehicle of claim 1, further comprising a tote fill feedback device that generates a feedback signal responsive to at least one of a fill level and arrangement of the tote fill.

7. The autonomous transport vehicle of claim 6, wherein the tote fill feedback device is at least one of a camera that views the payload and camera that views the tote at the tote fill location.

8. The autonomous transport vehicle of claim 1, wherein the fill placement regulator, of the end effector, effects repeatably retraction of the end effector to the closed position at each placement of the goods unit independent of obstruction from the tote fill at each placement.

9. The autonomous transport vehicle of claim 1, wherein the end effector has a movable wall, that moves with retraction of the end effector so as to clear each tote fill obstruction.

10. A method for transferring a goods unit for filling a shipping tote or container, the method comprising:
providing an autonomous transport vehicle having a frame and a payload connected to the frame, the frame being configured so that the autonomous transport vehicle traverses, as a unit, on at least one of a transfer deck and a ramp, and the payload holds the goods unit loaded on the autonomous transport vehicle;
effecting movement of the autonomous transport vehicle, with a controller connected to the frame, on the at least one of the transfer deck and the ramp so that the autonomous transport vehicle roams freely via autonomous navigation, from a first location to a different second location, wherein the first location is a supply of the goods unit, and the second location is a tote fill location based on an order; and
unloading the goods unit from the payload with an end effector of the payload, the end effector being arranged to extend and unload the goods unit from the payload, where the end effector forms a fill placement regulator that regulates placement of the goods unit unloaded in filling the tote so that each tote at each tote fill location is repeatably filled, with a tote fill, substantially to a predetermined fill level.

11. The method of claim 10, further comprising regulating, with the fill placement regulator, each tote fill substantially agnostic with respect to size, shape and quantity of each goods unit in the tote fill of a common tote.

12. The method of claim 10, wherein the end effector has at least one side wall containing the payload, the method further comprising:
extending the end effector from a closed location to an open extended position; and
unloading the goods unit from the payload with a justification feature of the end effector that contacts the goods unit so as to offload the goods unit from the payload.

13. The method of claim 10, further comprising biasing, with a justification feature of the end effector that is disposed so as to the tote fill, goods units of the tote fill during extension or retraction of the end effector, so as to regulate the tote fill of each tote substantially to the repeatable fill level.

14. The method of claim 10, further comprising effecting, with the end effector of the autonomous transport vehicle, controllable fill of the tote with the tote fill of goods units via a tote fill feedback device responsive to at least one of a fill level and arrangement of the tote fill.

15. The method of claim 10, further comprising generating, with a tote fill feedback device, a feedback signal responsive to at least one of a fill level and arrangement of the tote fill.

16. The method of claim 6, wherein the tote fill feedback device is at least one of a camera that views the payload and camera that views the tote at the tote fill location.

17. The method of claim 10, further comprising effecting, with the fill placement regulator of the end effector, repeatable retraction of the end effector to the closed position at each placement of the goods unit independent of obstruction from the tote fill at each placement.

18. The method of claim 10, wherein the end effector has a movable wall, that moves with retraction of the end effector so as to clear each tote fill obstruction.

19. An autonomous transport vehicle for transferring a goods unit for filling a shipping tote or container, the vehicle comprising:
a frame configured so that the autonomous transport vehicle traverses, as a unit, on at least one of a transfer deck and a ramp;
a controller connected to the frame and configured to effect movement of the vehicle on the at least one of the transfer deck and the ramp so that the vehicle roams freely via autonomous navigation, from a first location to a different second location, wherein the first location is a supply of the goods unit, and the second location is a tote fill location of based on an order; and
a payload connected to the frame for holding the goods unit loaded on the vehicle, the payload forms a tray having sides that are movably connected to the payload so as to extend outward, away from the frame, from a closed position, closing the payload, and an extended position, opening the payload, the sides of the tray forming an end effector that, opens the payload, engages and controllably moves the payload, with extension of the tray that unloads the goods unit from the payload.

20. The autonomous transport vehicle of claim 19, wherein the sides of the tray is are configured to slide, with at least one degree of freedom, that extends and retracts the sides of the tray so as to open and close the payload.

21. The autonomous transport vehicle of claim 19, wherein the sides of the tray have a justification edge that biases the tote fill so as to conform the tote fill to a substantially predetermined level.
